(19) United States
(12) Patent Application Publication
(10) Pub. No.: US 2022/0288739 A1
(43) Pub. Date: Sep. 15, 2022

(54) SENSOR SYSTEM, WIRELESS TERMINAL, AND WIRELESS COMMUNICATION APPARATUS

(71) Applicant: KYOCERA CORPORATION, Kyoto-shi, Kyoto (JP)

(72) Inventors: Chiharu YAMAZAKI, Ota-ku, Tokyo (JP); Sunao HASHIMOTO, Yokohama-shi, Kanagawa (JP)

(21) Appl. No.: 17/632,789

(22) PCT Filed: Aug. 4, 2020
(86) PCT No.: PCT/JP2020/029792

§ 371 Date: Feb. 3, 2022

(30) Foreign Application Priority Data
Aug. 5, 2019 (JP) 2019-143676

(51) Int. Cl. B23Q 17/22; H04W 4/38; H04W 52/02

(52) U.S. Cl. CPC B23Q 17/22; H04W 4/38; H04W 52/02

(57) ABSTRACT

A sensor system may include a base, one or more wireless communication sensors attached to the base, and a wireless communication apparatus that performs wireless communication with the wireless communication sensors. The wireless communication sensors may include a sensor that detects a position of the wireless communication sensor, a wireless communication module that performs wireless communication with the wireless communication apparatus, and a controller that controls the sensor and the wireless communication module. The controller, when the position of the wireless communication sensor, detected by the sensor, satisfies a predetermined condition, may change a status of wireless communication between the wireless communication module and the wireless communication apparatus from a first state to a second state in which an electric power consumption of the wireless communication module is greater than in the first state.

### RELATED APPLICATIONS

The present application is a National Phase of International Application No. PCT/JP2020/029792, filed Aug. 4, 2020, which claims priority to Japanese Application No. 2019-143676, filed Aug. 5, 2019.

### TECHNICAL FIELD

The present disclosure may relate to a sensor system that detects a physical quantity and that performs wireless communication, a wireless terminal included in the sensor system, and a wireless communication apparatus that is included in the sensor system and that performs wireless communication with the wireless terminal.

### BACKGROUND ART

There may be known a sensor system that includes a sensor, a wireless communication module that sends data on a detection result of the sensor, and a wireless communication apparatus that receives data sent from the wireless communication module (PTL 1). In PTL 1, the sensor and the wireless communication module may be provided in a cutting tool. The wireless communication apparatus may be an apparatus outside the cutting tool.

### CITATION LIST

### Patent Literature

PTL 1: U.S. Patent Application Publication No. 2019/0030672

### SUMMARY OF INVENTION

A sensor system according to an aspect of the present disclosure may include a base, one or more wireless communication sensors attached to the base, and a wireless communication apparatus that performs wireless communication with the wireless communication sensors. The wireless communication sensor may include a sensor that detects a position of the wireless communication sensor, a wireless communication module that performs wireless communication with the wireless communication apparatus, and a controller that controls the sensor and the wireless communication module. The controller, when the position of the wireless communication sensor, detected by the sensor, satisfies a predetermined condition, may change a status of wireless communication between the wireless communication module and the wireless communication apparatus from a first state to a second state in which an electric power consumption of the wireless communication module is greater than in the first state.

A wireless terminal according to an aspect of the present disclosure may include a base, and one or more wireless communication sensors attached to the base. The wireless communication sensor may include a sensor that detects a position of the wireless communication sensor, a wireless communication module that performs wireless communication with an external apparatus, and a controller that controls the sensor and the wireless communication module. The controller, when the position of the wireless communication sensor, detected by the sensor, satisfies a predetermined condition, may change a status of wireless communication from a first state to a second state in which an electric power consumption of the wireless communication module is greater than in the first state.

A wireless communication apparatus according to an aspect of the present disclosure may perform wireless communication with wireless communication sensors attached to the same base. The wireless communication apparatus, in response to a change of the status of wireless communication of any one of the wireless communication sensors from a first state to a second state in which communication traffic per unit time is higher than in the first state, may send first data to another one of the wireless communication sensors of which the status of wireless communication is already the second state.

### BRIEF DESCRIPTION OF DRAWINGS

FIG. 1 is a block diagram showing the configuration of a sensor system according to an embodiment.

FIG. 2 is a perspective view showing a relevant part of a machine tool included in the sensor system of FIG. 1.

FIG. 3A, FIG. 3B, and FIG. 3C are schematic views showing examples of mounting locations for wireless communication sensors included in the sensor system of FIG. 1.

FIG. 4A and FIG. 4B are block diagrams respectively showing an example and another example of the wireless communication sensors included in the sensor system of FIG. 1.

FIG. 5 is a schematic view for illustrating the outline of a change of a communication status in the wireless communication sensors.

FIG. 6A, FIG. 6B, FIG. 6C, and FIG. 6D are schematic views for illustrating the outline of a trigger to change the communication status in a first example.

FIG. 7 is a flowchart showing an example of the outline of the procedure of a main process to be executed by the wireless communication sensors in the first example.

FIG. 8 is a flowchart showing an example of the outline of the procedure of a main process to be executed by a wireless communication apparatus in the first example.

FIG. 9 is a flowchart showing an example of the procedure of a process to be executed in step ST2 of FIG. 7.

FIG. 10 is a flowchart showing an example of the procedure of a process to be executed in step ST7 of FIG. 7.

FIG. 11 is a flowchart showing an example of the procedure of a process on detection of a state of a base and sending of the detection result in the process of FIG. 7.

FIG. 12A, FIG. 12B, FIG. 12C, and FIG. 12D are schematic views for illustrating the outline of a trigger to change the communication status in a second example.

FIG. 13 is a flowchart showing an example of the outline of the procedure of a main process to be executed by the wireless communication sensors in the second example.

FIG. 14 is a flowchart showing an example of the outline of the procedure of a main process to be executed by a wireless communication apparatus in the second example.

### DESCRIPTION OF EMBODIMENTS

(Outline of Sensor System)

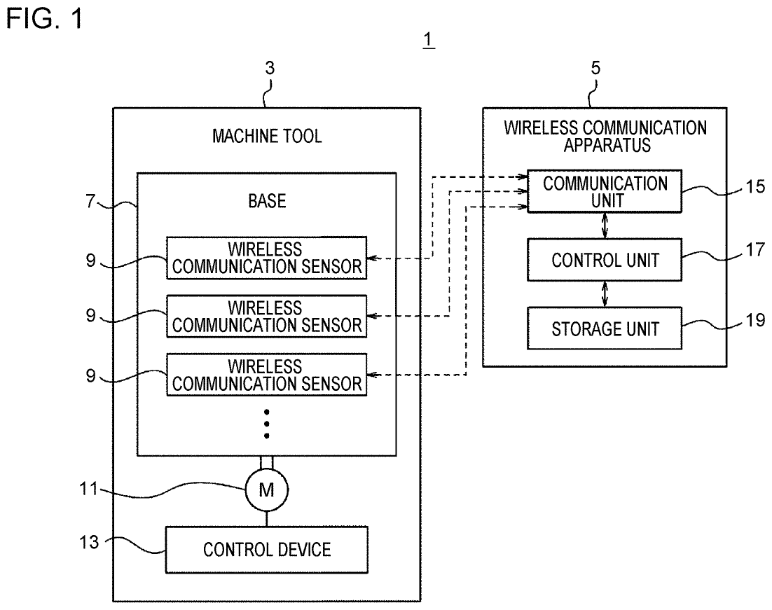

FIG. 1 may be a block diagram showing the configuration of a sensor system 1 according to an embodiment.

The sensor system 1 may include a machine tool 3 serving as an example of a wireless terminal, and a wireless communication apparatus 5 that performs wireless communication with the machine tool 3. Through wireless communication between the machine tool 3 and the wireless communication apparatus 5, for example, information on the state of the machine tool 3 can be accumulated in the wireless communication apparatus 5, and the accumulated information can be used for maintenance and management, control, and/or the like of the machine tool 3.

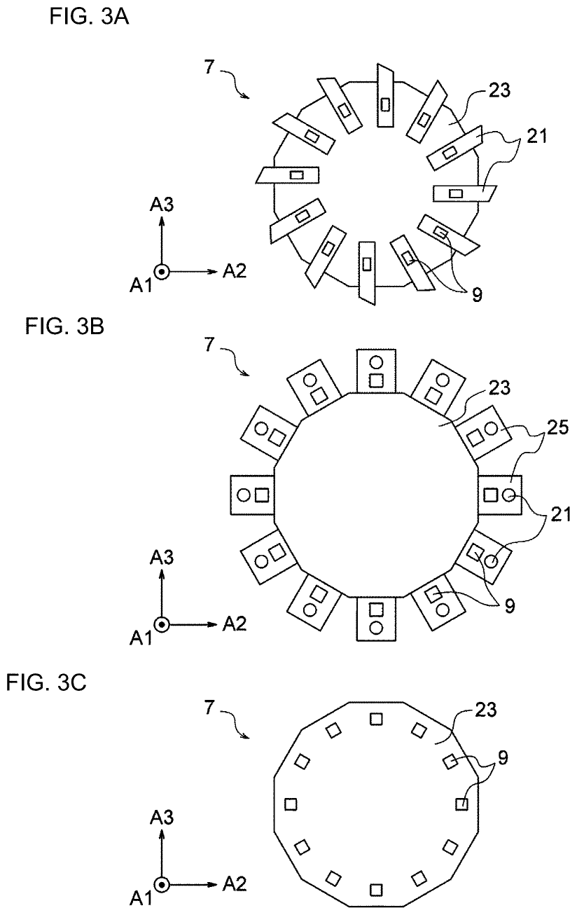

The machine tool 3 may include a base 7, and one or more wireless communication sensors 9 attached to the base 7. As in the case of an example shown in FIG. 3A to FIG. 3C, the machine tool 3 may include the wireless communication sensors 9. Each of the wireless communication sensors 9, for example, may detect a predetermined physical quantity. Each of the wireless communication sensors 9 may perform wireless communication with the wireless communication apparatus 5. For example, each wireless communication sensor 9 may send a detection result of the physical quantity to the wireless communication apparatus 5.

The machine tool 3 may include, for example, a driving source 11 that generates driving force for changing the position of the base 7 (the position of the wireless communication sensor 9 from another viewpoint), and a control device 13 that controls the driving source 11. Other than the above, the machine tool 3 may include, for example, a communication unit that performs wireless communication with the wireless communication apparatus 5 in addition to the wireless communication sensors 9. In the description of the present embodiment, the whole of the machine tool 3 including the driving source 11 and the control device 13 may be described as an example of the wireless terminal. The wireless terminal may be defined as part of a machine tool (the base 7 and the wireless communication sensors 9) (except the driving source 11 and the control device 13).

The wireless communication apparatus 5 may include a communication unit 15 that is directly in charge of wireless communication with the wireless communication sensors 9, a control unit 17 that controls the communication unit 15, and a storage unit 19 that stores information obtained via the communication unit 15. In the description of the present embodiment, the wireless communication apparatus 5 may be assumed as an apparatus different from the machine tool 3. However, the machine tool may be defined as including the wireless communication apparatus 5.

(Outline Configuration of Machine Tool)

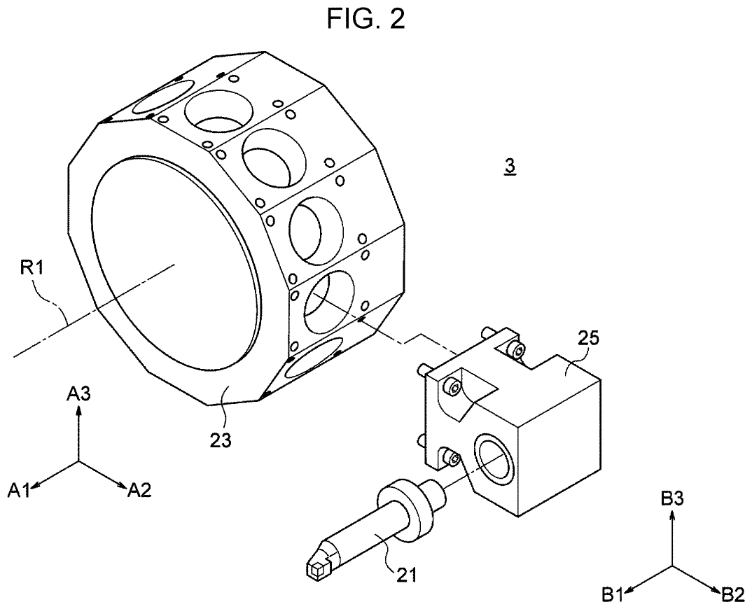

FIG. 2 may be a perspective view showing a relevant part of the machine tool 3 according to the embodiment.

An orthogonal coordinate system consisting of A1-axis, A2-axis, and A3-axis may be set in FIG. 2 for the sake of convenience. The coordinate system may be assumed as a substantially absolute coordinate system, and a relative relationship between the coordinate system and each of a vertical direction and a horizontal direction may be any relationship.

An orthogonal coordinate system consisting of B1-axis, B2-axis, and B3-axis may also be set in FIG. 2. The coordinate system may be assumed as a relative coordinate system fixed to each wireless communication sensor 9. The same number of the coordinate systems B1-B2-B3 as the number of the wireless communication sensors 9 may be defined; however, only one coordinate system B1-B2-B3 may be shown here. The orientation of each axis will be described later.

The machine tool 3 may be configured as, for example, a turning center (a type of lathe). The machine tool 3, for example, may cut a work material by bringing a turning tool (tool bit or the like) serving as a cutting tool 21 into contact with the work material rotating around an axis parallel to the A1-axis. The machine tool 3 may be capable of cutting a work material by rotating a rotating tool (drill, end mill, or the like) serving as the cutting tool 21 in a state where rotation of the work material is stopped.

The machine tool 3 may include, for example, a turret 23 as a component for holding the cutting tool 21. The turret 23 may be capable of directly holding cutting tools 21 (see FIG. 3A (described later)), may be capable of indirectly holding the cutting tool 21 via a tool block 25 (tool holder) attached to the turret 23 (the example of FIG. 2), or may be capable of both.

The turret 23 may be capable of directly or indirectly holding the cutting tools 21 along its outer periphery (only one cutting tool 21 is illustrated in FIG. 2). The turret 23, for example, may contribute to replacement of the cutting tool 21 used to cut a work material by rotating around a rotation axis R1 decentered from the rotation axis of the work material. Thus, the type and/or orientation of the cutting tool 21 used for cutting is able to be changed in a short time, and, by extension, various machining processes are able to be efficiently performed.

The configuration of the cutting tool 21, the configuration of the turret 23, the configuration of the tool block 25, and the like may be selected as needed. For example, the number of cutting tools 21 (or tool blocks 25; hereinafter, the same applies in this paragraph) that the turret 23 is capable of holding may be selected number. In the illustrated example, as is understood from the configuration that the turret 23 is formed in a regular dodecagon, the turret 23 may be capable of holding 12 cutting tools 21. For example, the turret 23 may hold a cutting tool 21 on the positive A1-side face or hold a cutting tool 21 on an outer peripheral surface around the rotation axis R1. The tool block 25 may be capable of holding two or more cutting tools 21.

(Example of Locations of Wireless Communication Sensors)

FIG. 3A to FIG. 3C may be schematic views respectively showing examples of mounting locations for the wireless communication sensors 9. The drawings may be views of the turret 23 from the positive A1 side.

In the example of FIG. 3A, the turret 23 may directly hold the cutting tools 21. The wireless communication sensors 9 may be individually provided on the cutting tools 21. In this case, the turret 23 and the cutting tools 21 (body portions excluding the wireless communication sensors 9) may make up the base 7.

In the example of FIG. 3B, the turret 23 may indirectly hold the cutting tools 21 via tool blocks 25. The wireless communication sensors 9 may be individually provided on the tool blocks 25. In this case, the turret 23 and the tool blocks 25 (body portions excluding the wireless communication sensors 9) may make up the base 7. In this example, as in the case of FIG. 3A, the definition of the base 7 may include the cutting tools 21.

In the example of FIG. 3C, the wireless communication sensors 9 may be provided at portions of the turret 23 where the cutting tools 21 is directly or indirectly held. In this case, the turret 23 (a body portion excluding the wireless communication sensors 9) may make up the base 7. In this example, as in the case of the other examples, the definition of the base 7 may include the cutting tools 21 and/or the tool blocks 25.

As is understood from these examples, the wireless communication sensors 9 may be individually provided on the cutting tools 21 (and/or the tool blocks 25; the same applies in this paragraph) directly or indirectly held by the turret 23. Thus, for example, it may be possible to detect the state of each cutting tool 21 (detect the state of the base 7 for each cutting tool 21).

The examples of FIG. 3A to FIG. 3C may be combined as needed. For example, of the mounting locations (12 in the illustrated example) of the turret 23, any one example of FIG. 3A to FIG. 3C may be applied to one or some of the mounting locations, and another example of FIG. 3A to FIG. 3C may be applied to the others of the mounting locations. For example, the cutting tool 21 on which the wireless communication sensor 9 is provided may be indirectly held by the turret 23 via the tool block 25.

Hereinafter, basically, the mode in which the wireless communication sensors 9 are respectively provided on the cutting tools 21 will be shown in the drawings and described as an example. However, the other modes described with reference to FIG. 3B and FIG. 3C may be, of course, applied to the following description.

(Wireless Communication Sensor)

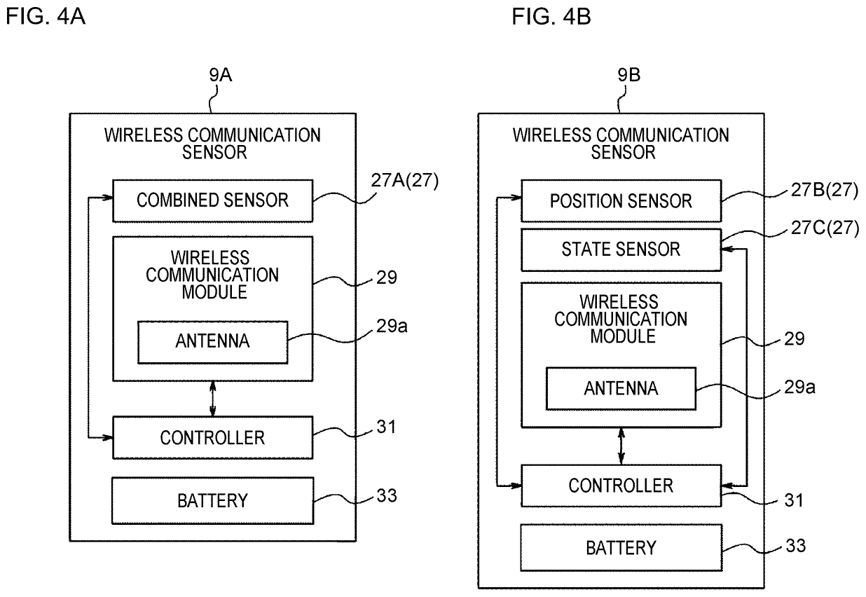

FIG. 4A may be block diagram showing the configuration of a wireless communication sensor 9A that is an example of the wireless communication sensor 9. FIG. 4B may be block diagram showing the configuration of a wireless communication sensor 9B that is another example of the wireless communication sensor 9.

The wireless communication sensor 9A may include a combined sensor 27A that is directly in charge of detecting a physical quantity, a wireless communication module 29 that is directly in charge of wireless communication, a controller 31 that controls these components, and a battery 33 that supplies electric power to these components. The wireless communication sensor 9B may be configured such that, in the wireless communication sensor 9A, a position sensor 27B and a state sensor 27C are provided instead of the combined sensor 27A. In the following description, the combined sensor 27A, the position sensor 27B, and the state sensor 27C may be simply referred to as “sensor 27” without being distinguished from one another. The wireless communication sensor 9A and the wireless communication sensor 9B may be not distinguished from each other.

(Sensor)

The sensor 27 may be only a transducer portion that converts a physical quantity to an electrical signal (may be a sensor in a narrow sense) or may include an amplifier and the like in addition to a transducer. The sensor 27 may include, for example, a microcomputer capable of performing various processes (for example, edge treatment) to a measured physical quantity. The sensor 27 may be the one that consumes electric power or may be the one that does not consume electric power. In the description of the present disclosure, basically, the one that consumes electric power may be taken as an example of the sensor 27.

(Position Sensor)

The position sensor 27B may contribute to, for example, detecting the position of the wireless communication sensor (the wireless communication sensor 9B to which the position sensor 27B belongs). In the present embodiment, the wireless communication sensor 9 nay be fixed to the base 7 and may rotate around the rotation axis R1. Therefore, here, the position of the wireless communication sensor may be an orientation in a plane (A2-A3 plane) orthogonal to the rotation axis R1. The position of the wireless communication sensor may correspond to the position of the base 7 (the rotational position of the base 7 around the rotation axis R1).

An orientation in the A2-A3 plane as the position of the wireless communication sensor may be defined with reference to a selected portion (selected direction) in the wireless communication sensor. In the following description, for the sake of convenience, the orientation of each wireless communication sensor 9 may be described by using the relative coordinate system B1-B2-B3 (FIG. 2) fixed to the wireless communication sensor 9. The B1-axis may be assumed as an axis parallel to the A1-axis (rotation axis R1). The B2-axis may be assumed as an axis parallel to a line connecting the rotation axis R1 and the wireless communication sensor 9 (the radius of the turret 23). The B3-axis may be assumed as an axis parallel to a tangential direction of rotation of the turret 23.

Specific examples of the physical quantity to be detected in order to detect the position of the wireless communication sensor may include an acceleration and a magnetism. In other words, the position sensor 27B may be made up of an acceleration sensor, a magnetic sensor, or a combination of these sensors.

For example, in a state where no acceleration is externally added by rotation of the turret 23, cutting with the cutting tool 21, or the like, the direction in which the acceleration is the largest may be regarded as the direction of gravity. Therefore, by detecting the acceleration with the acceleration sensor serving as the position sensor 27B, it may be possible to identify the position of the wireless communication sensor (for example, the inclination angle of the B2-axis with respect to the direction of gravity, or the like). Alternatively, by applying measurement results of acceleration in a certain period of time to averaging (or low-pass filter), the direction of gravity that is a direct-current component of acceleration may be detected. A computation to identify the position of the wireless communication sensor based on acceleration may be performed not by the position sensor 27B but by the controller 31. In this case as well, the acceleration sensor may be regarded as a sensor that detects the position of the wireless communication sensor. The acceleration sensor may be, for example, a suitable one, such as a capacitive semiconductor sensor and a piezoresistive semiconductor sensor.

When a magnetic field at the location of the position sensor 27B is basically due to geomagnetism, it may be apparently possible to identify the position of the wireless communication sensor with the position sensor 27B serving as a magnetic sensor (in other words, a geomagnetic sensor). As in the case of the acceleration sensor, a computation to identify the position of the wireless communication sensor based on magnetism may be performed not by the position sensor 27B but by the controller 31. In this case as well, the geomagnetic sensor may be regarded as a sensor that detects the position of the wireless communication sensor. The geomagnetic sensor may be, for example, an appropriate one, such as a Hall sensor and a magnetoresistive sensor.

(State Sensor)

The state sensor 27C may contribute to measuring the state of the cutting tool 21 (the state of the base 7 from another viewpoint; hereinafter, the same applies). Examples of the state of the cutting tool 21 may include physical quantities, such as temperature, acceleration, vibration, strain, internal stress, and wear. From another viewpoint, the state sensor 27C may be any one of an acceleration sensor, a geomagnetic sensor, an angular velocity sensor, an AE (acoustic emission) sensor, a temperature sensor, and a stress strain sensor. Measuring the state of the cutting tool 21 may mean measuring information on at least one of the above-described typical physical quantities in the cutting tool 21. A measuring object is not limited to information in a static state and may be information in a dynamic state, that is, a change in state.

For example, information on a measuring object may be defined as temperature. It may be assumed that the temperature of the cutting tool 21 before cutting is 20° C. and the temperature of the cutting tool 21 increases to 80° C. during cutting work. At this time, 20° C. that is the temperature of the cutting tool 21 before cutting work may be information on temperature in a static state. An increase in the temperature of the cutting tool 21 from 20° C. to 80° C. may be information on temperature in a dynamic state. Any one of these pieces of information may be measured or both may be measured.

When, for example, the state sensor 27C includes a thermocouple, it may be possible to measure the temperature of the cutting tool 21. When the state sensor 27C includes a piezoelectric sensor using a piezoelectric element as well, it may be possible to measure acceleration, vibration, strain, internal stress, or the like. The state sensor 27C may include a wiring circuit that functions as a sensor. Specifically, when the wiring circuit wears with wear of a block body 45 and the resistance value of the circuit changes, a wear state of the block body 45 may be measured in accordance with a change in the resistance value.

The state of the cutting tool 21, which can be measured with the state sensor 27C, is not limited to the above-described physical values. The state sensor 27C is not limited to the above-described specific examples, and other not described elements capable of measuring the above-illustrated physical values may be used. For example, a camera and a microphone may be used.

(Combined Sensor)

The combined sensor 27A may serve as both the position sensor 27B and the state sensor 27C. In other words, the combined sensor 27A may contribute to detecting the position of the wireless communication sensor (the wireless communication sensor 9A to which the combined sensor 27A belongs) and may contribute to detecting the state of the cutting tool 21 associated with the wireless communication sensor.

Therefore, initially, the description of the position sensor 27B may also be used for the combined sensor 27A. In other words, the combined sensor 27A may be made up of, for example, an acceleration sensor, a geomagnetic sensor, or a combination of both.

Various physical quantities, such as temperature, acceleration, vibration, strain, internal stress, and wear, may be illustrated as physical quantities to be detected by the state sensor 27C. However, the combined sensor 27A may also be used to detect the position of the wireless communication sensor as described above, so physical quantities here may be, for example, acceleration and/or vibration.

It may apparently be possible to detect an acceleration with the combined sensor 27A serving as an acceleration sensor. When an acceleration is continuously detected, it may be possible to detect a vibration state. Continuous detection may be actually, of course, detection at intervals of a certain sampling period. When the base 7 vibrates, the orientation (position) of the wireless communication sensor 9A may also repeatedly change minutely. Therefore, it may also be possible to detect a vibration state even with the combined sensor 27A serving as a geomagnetic sensor.

(Wireless Communication Module)

The wireless communication module 29 may contribute to, for example, wirelessly sending a physical quantity detected by the sensor 27 (and/or information based on the physical quantity; hereinafter, the same applies) to an apparatus (wireless communication apparatus 5) outside the wireless communication sensor 9. The wireless communication module 29 may contribute to, for example, wirelessly receiving a signal from an external apparatus (wireless communication apparatus 5). A signal from the wireless communication apparatus 5 may include, for example, information used to control the operation of the wireless communication sensor 9.

Examples of wireless communication to be performed by the wireless communication module 29 may include the one using radio wave. In this case, the wireless communication module 29 may include, for example, an antenna 29a. The wireless communication module 29, for example, may modulate and may raise in frequency an electrical signal from the controller 31 (which can be an electrical signal from the sensor 27) (converts into a radio-frequency signal having a carrier frequency), then the wireless communication module 29 may convert the radio-frequency signal to radio wave with the antenna 29a, and may send the radio wave. The wireless communication module 29, for example, may receive radio wave serving as a wireless signal with the antenna 29a and may convert the received radio wave to an electrical signal with the antenna 29a. The electrical signal may be, for example, demodulated and lowered in frequency by the wireless communication module 29 and output to the controller 31. Wireless communication is not limited to the above one and may be, for example, the one using light.

A range in which a wireless signal to be sent by the wireless communication module 29 reaches (range in which the wireless communication module 29 directly performs wireless communication) may be narrow or broad. For example, the range may be a range that covers around the machine tool 3, may be a range that covers one factory (building), may be a range that covers one site in which factories are built, may be a range that covers a region, such as a municipality, or may be a range broader than the region.

(Controller)

The controller 31 may be configured to include, for example, a computer. The computer may include a CPU (central processing unit), a RAM (random access memory), a ROM (read only memory), and an external storage device. Various functional units that execute various processes may be constructed by the CPU running a program stored in the ROM and/or the external storage device. The operation of the controller 31 will be described later.

(Battery)

The type, capacity of electric energy storage, shape, dimensions, and the like of the battery 33 may be set as needed. Examples of the type of the battery 33 may include a lithium ion battery. The capacity of electric energy storage of the battery 33 may be shorter than one hour, may be longer than or equal to one hour, may be longer than or equal to one day, or may be longer than or equal to one week, in term of a time during which the wireless communication sensor 9 can be driven.

(Wireless Communication Apparatus)

Refer back to FIG. 1. The wireless communication apparatus 5 may be placed relatively close to the machine tool 3 or may be placed relatively far from the machine tool 3. The wireless communication apparatus 5 may be made up of pieces of hardware placed in a distributed manner in places. For example, part or whole of the wireless communication apparatus 5 may be placed adjacent to the machine tool 3, may be placed away from the machine tool 3 in a factory (building) in which the machine tool 3 is placed, may be placed in another building in the same site as a site in which the factory is built, may be placed in another region in the same region as a region in which the site is located, or may be placed in a region or country different from the region.

The wireless communication apparatus 5 may communicate with the wireless communication sensor 9 by, for example, directly sending and/or receiving a wireless signal to and/or from the wireless communication sensor 9 or may communicate with the wireless communication sensor 9 via another apparatus and/or communication network that sends and/or receives a wireless signal to and/or from the wireless communication sensor 9. Examples of the communication network may include the Internet. As described above, when pieces of hardware placed in a distributed manner is regarded as the wireless communication apparatus 5, the above-described other apparatus and/or communication network may be regarded as part of the wireless communication apparatus 5.

The wireless communication apparatus 5 may be configured to include, for example, a computer. The computer may include a CPU, a RAM, a ROM, and an external storage device. Various functional units that execute various processes may be constructed by the CPU running a program stored in the ROM and/or the external storage device. FIG. 1 may show the already-described communication unit 15 and control unit 17 as functional units. The RAM and/or the external storage device may function as the already-described storage unit 19. The storage unit 19, for example, may accumulate information (for example, the state of the cutting tool 21) based on a signal output by the sensor 27 (27A or 27C).

As is understood from the above description, the communication unit 15 may directly send and/or receive a wireless signal to and/or from the wireless communication sensor 9 or may send and/or receive a signal to and/or from the wireless communication sensor 9 via another apparatus and/or a communication network. The configuration of the communication unit 15 may be an appropriate one according to the above-described receiving mode. For example, the communication unit 15 may include an antenna that sends and/or receives radio wave serving as a wireless signal and may include a demodulator that demodulates an input radio-frequency signal.

A process to be executed by the control unit 17 may be an appropriate one. For example, the control unit 17 may execute a process of accumulating information included in a signal, output by the sensor 27 (27A or 27C) and obtained via the communication unit 15, in the storage unit 19. For example, the control unit 17 may execute a process of evaluating the state of the cutting tool 21 in accordance with information obtained from the sensor 27 and/or information accumulated in the storage unit 19. For example, the control unit 17 may output a signal providing an instruction to change a machining condition to the machine tool 3 in accordance with the evaluation result or may display an image based on the evaluation result on a display. In accumulation of information, for example, information on the state of the cutting tool 21, sequentially sent from the wireless communication sensor 9, may be sequentially stored in the storage unit 19, and time-series data may be generated.

The wireless communication apparatus 5 may be capable of communicating with the machine tools 3 (their wireless communication sensors 9) and may receive information from the machine tools 3. The wireless communication apparatus 5 may generate so-called big data by using accumulation of information. Conversely, information may be sent from one machine tool 3 to the wireless communication apparatuses 5.

(Outline of Change of Communication Status and Others)

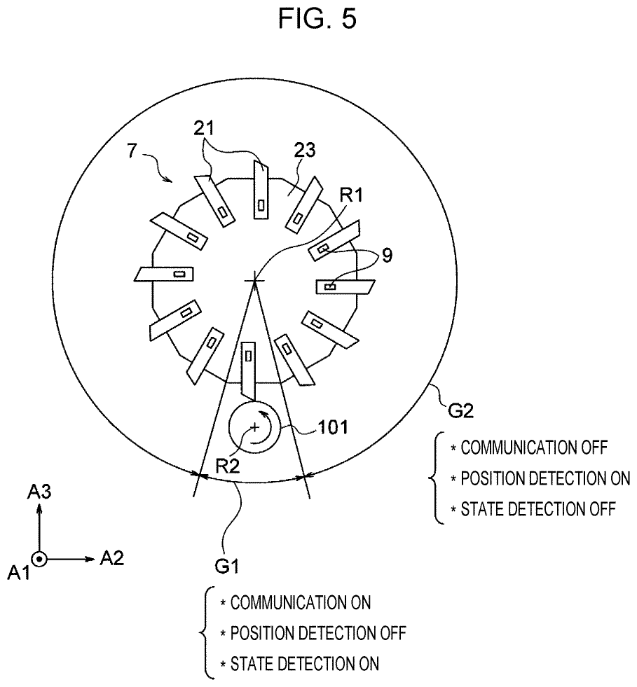

FIG. 5 may be a schematic view for illustrating the outline of a change of the status and the like of wireless communication in the wireless communication sensors 9 and, as in the case of FIG. 3A, a view of part of the machine tool 3 from the positive A1 side.

In FIG. 5, the rotation axis R1 may be decentered to the positive A3 side with respect to the rotation axis R2 of a work material 101. Of course, the direction in which the rotation axis R1 is decentered may be another direction. However, in the following description, for the sake of convenience, as shown in FIG. 5, it may be assumed that the cutting tool 21 located on the negative A3 side with respect to the rotation axis R1 is used to cut a work material.

It may be assumed that, when the work material 101 is being cut, one of the cutting tools 21 is used for cutting and the other cutting tools 21 are in a standby state. Within an angular range around the rotation axis R1, a range including the cutting tool 21 used for cutting may be defined as a first range G1. The remaining range may be defined as a second range G2. The first range G1 and the second range G2 may be regarded as the range of the position of the wireless communication sensor 9. More specifically, the first range G1 and the second range G2 each may be a range in which the positive side of the B2-axis (FIG. 2) falls.

Each of the wireless communication sensors 9 may be, for example, capable of determining whether the position of the wireless communication sensor falls within the first range G1 or the second range G2 in accordance with the position of the wireless communication sensor, detected by the sensor 27 (27A or 27B), and/or other information. Each of the wireless communication sensors 9, when the position of the wireless communication sensor falls within the first range G1, for example, may set detection of the state of the cutting tool 21 to ON and may set the state of wireless communication to ON. On the other hand, each of the wireless communication sensors 9, when the position of the wireless communication sensor falls within the second range G2, for example, may set detection of the state of the cutting tool 21 to OFF and may set the state of wireless communication to OFF.

For information on the state of the cutting tool 21 to be detected by the sensor 27 (27A or 27C), generally, information during cutting work may be useful. Therefore, as described above, only when the position of the wireless communication sensor 9 falls within the first range G1, detection of the state of communication and/or the state of the cutting tool 21 may be set to ON, with the result that it is possible to reduce an electric power consumption.

Detection of the position with the sensor 27 (27A or 27B) may be set to ON regardless of whether the wireless communication sensor falls within the first range G1 or the second range G2 or may be set to ON only when the wireless communication sensor falls within any one range. In FIG. 5, detection of the position may be set to ON when the wireless communication sensor falls within the second range G2 and may be set to OFF when the wireless communication sensor falls within the first range G1.

The size of the first range G1 may be, for example, an angle (360°/12=30° in the illustrated example) obtained by dividing 360° by the number of cutting tools 21 (or tool blocks 25) that can be attached to the turret 23. The size of the first range G1 may be greater or less than such an angle. For example, the size of the first range G1 may be set to a size (for example, less than or equal to 1°) close to positioning accuracy of the turret 23 in the rotation direction. The center of the first range G1, when, for example, the cutting tool 21 used for cutting is positioned, may substantially coincide with the position (B2-axis direction) of the wireless communication sensor 9 associated with that cutting tool 21. However, misalignment may be allowed.

(Details of ON and OFF)

In the above description, the words “ON” and “OFF” may be used for communication status, detection of the position, and detection of the state of the cutting tool 21. However, this may be for the sake of convenience for easy description. For example, OFF may include not only a state where electric power is not consumed at all but also a state where electric power is consumed and an electric power consumption is reduced as compared to ON. In other words, ON and OFF may be respectively appropriate states as long as, for example, OFF may be less in electric power consumption than ON.

For example, a combination of OFF and ON of the communication status may be regarded as a combination of a first state and a second state in which an electric power consumption of the wireless communication module 29 is greater than in the first state. Here, an electric power consumption may be replaced with the word communication load or communication traffic (hereinafter, the same applies). For an electric power consumption, a value per unit time may be compared between the first state and the second state.

A unit time may be set as needed. For example, a unit time, when data is sent and/or received at intervals of a certain period, may be set to a length longer than or equal to the period. A unit time may be set to a length shorter than or equal to a time length during which each cutting tool 21 is used for cutting. Hereinafter, the same may apply.

More specifically, examples of the combination of the first state and the second state may include a combination of a state where communication is disconnected and a state where communication is established. The state where communication is established may be, for example, a state where authentication is complete between the wireless communication sensor 9 and the wireless communication apparatus 5 and data is allowed to be sent and/or received between the wireless communication sensor 9 and the wireless communication apparatus 5. The state where communication is disconnected may be a state where the above-described authentication is not performed, and, from another viewpoint, a state where communication is not performed at all. In the state where communication is established, for example, data including a detection result of the sensor 27 may be sent and/or a signal for maintaining the state where communication is established may be sent and received, so an electric power consumption may be greater than that in the state where communication is disconnected.

In the above description, the state where communication is disconnected may be a state where driving of the wireless communication module 29 is stopped (state where electric power is not supplied to the wireless communication module 29 at all) or may be a state where electric power is supplied to the wireless communication module 29. Examples of the latter state may include a state where electric power is supplied in order to hold information stored in the RAM of the wireless communication module 29.

Examples of the combination of the first state and the second state may include a combination of a state where the communication status is inactive (which may also be referred to as deactivated or sleep mode) and a state where the communication status is active. The state where the communication status is inactive may be, for example, a state where communication is established as described above but communication traffic (by extension, an electric power consumption) per unit time may be low as compared to the state where the communication status is active.

The difference in communication traffic between the state where the communication status is active and the state where the communication status is inactive may be, for example, due to the presence or absence or frequency of sending of data including a detection result of the sensor 27 or may be due to the presence or absence or frequency of sending and receiving a signal for maintaining established communication. The inactive state may include various modes (levels), and the first state may be any one of them.

ON and OFF of detection of the position and detection of the state of the cutting tool 21 may be various modes as in the case of the communication status. For example, ON of detection may be a state where detection using the sensor 27 is being performed and, in the present embodiment, it may be assumed that electric power is supplied to the sensor 27 (the sensor 27 is driven). Examples of OFF of detection may include a state where the sensor 27 is not driven (a state where electric power is not supplied to the sensor 27) and a state where the sensor 27 is inactive. Examples of the state where the sensor 27 is inactive may include a state where electric power (for example, electric power for causing the RAM to hold information) is supplied to the sensor 27 but detection with the sensor 27 is not performed and a state where detection with the sensor 27 is performed but a sampling rate is low as compared to ON.

As described above, the difference in communication traffic between the state where communication is active and the state where communication is inactive may be due to the presence or absence or frequency of sending of data including a detection result of the sensor 27. The presence or absence or frequency of sending of data may interlock with ON and OFF on detection with the sensor 27. Therefore, ON and OFF of the communication status may be in close relation to ON and OFF of detection and cannot always be conceptually distinguished. In other words, both do not always need to be distinguishable. However, in the following description, for the sake of convenience, ON of the communication status and ON of detection can be described side by side or OFF of the communication status and OFF of detection can be described side by side, including the case where both are in close relation to each other.

(First Example of Trigger to Change Communication Status and Others)

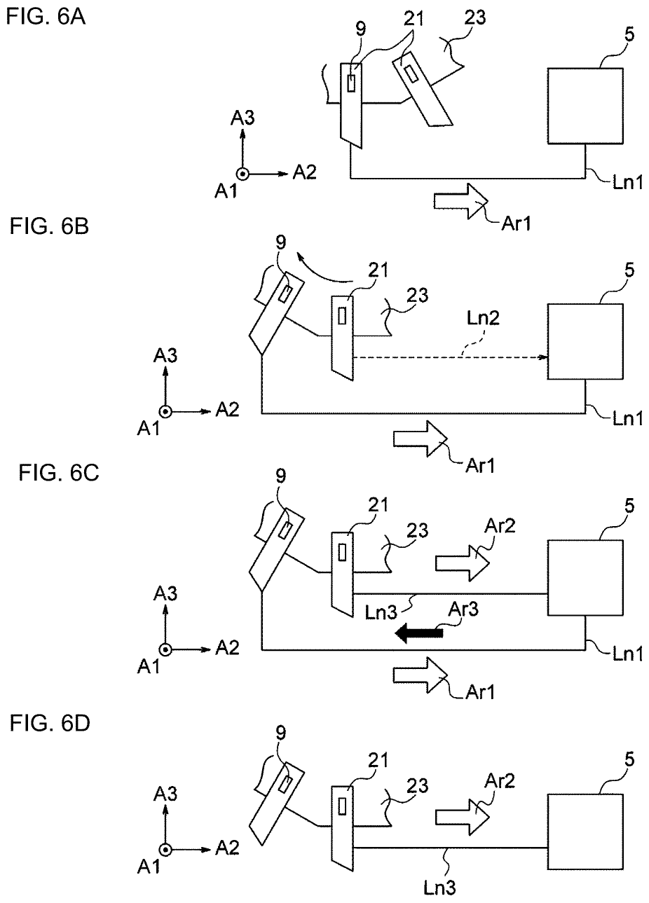

FIG. 6A to FIG. 6D may be schematic views for illustrating the outline of a trigger to change the communication status and the like.

In these drawings, part of the base 7 and the wireless communication apparatus 5 may be shown. As for the base 7, more specifically, two cutting tools 21 side by side with each other in a direction along the outer periphery of the turret 23 may be shown. Here, as shown in FIG. 6A, the case where the cutting tool 21 on the left-hand side of the sheet is used for cutting (positioned in the first range G1) and then, as shown in FIG. 6B to FIG. 6D, the cutting tool 21 on the right-hand side of the sheet is used for cutting may be taken as an example.

In the cutting tool 21 positioned at a location (first range G1) at which the cutting tool 21 is used for cutting in FIG. 6A, as described with reference to FIG. 5, the communication status may be set to ON, detection of the state of the cutting tool 21 may be set to ON, and detection of the position may be set to OFF. Here, a line Ln1 may indicate that communication is established, and an arrow Ar1 may indicate that data including a detection result on the state of the cutting tool 21 is sent.

On the other hand, in the cutting tool 21 positioned at a location (second range G2) at which the cutting tool 21 is not used for cutting in FIG. 6A, as described with reference to FIG. 5, the communication status may be set to OFF, detection of the state of the cutting tool 21 may be set to OFF, and detection of the position may be set to ON. Detection of the position may be performed at, for example, intervals of a certain sampling period (first period). OFF of the communication status may be various modes as already described. Here, as indicated by no line corresponding to the line Ln1 indicating that communication is established, the state where communication is disconnected as OFF of the communication status may be taken as an example.

After that, as shown in FIG. 6B, the control device 13 of the machine tool 3 may control the driving source 11 such that the turret 23 is rotated by a predetermined angle in accordance with a preset machining procedure (program) or in accordance with entry to an input device. Thus, the right-side cutting tool 21 located in the second range G2 may move to the first range G1, and the left-side cutting tool 21 located in the first range G1 may move to the second range G2.

The right-side wireless communication sensor 9 shifted from the second range G2 to the first range G1 may periodically detect the position of the wireless communication sensor, so it may be possible to determine whether the position of the wireless communication sensor falls with the first range G1 in accordance with the detection result. Then, when the right-side wireless communication sensor 9 determines that the position of the wireless communication sensor falls within the first range G1, the right-side wireless communication sensor 9 may be set the communication status to ON, may set detection of the state of the cutting tool 21 to ON, and may set detection of the position to OFF.

For example, the right-side wireless communication sensor 9 may send a request for establishing communication to the wireless communication apparatus 5 as indicated by an arrowed line Ln2. After that, as indicated by a line Ln3 in FIG. 6C, connection between the right-side wireless communication sensor 9 and the wireless communication apparatus 5 may be established. Then, as indicated by an arrow Art, the right-side wireless communication sensor 9 may start sending data including a detection result of the state of the cutting tool 21 to the wireless communication apparatus 5.

Any one of a process for setting the communication status to ON, a process for setting detection of the state of the cutting tool 21 to ON, and a process for setting detection of the position to OFF may be started first. Any one of the processes may be started on condition that another process is started or completed. In other words, a shift of the position of the wireless communication sensor to the first range G1 may be an indirect trigger to start various processes. For example, completion of a process of setting the communication status to ON (for example, establishment of communication) may be a trigger to start a process of setting detection of the state of the cutting tool 21 to ON.

In FIG. 6C, as indicated by the line Ln1 and the arrow Ar1, the wireless communication sensor 9 of the left-side cutting tool 21 shifted from the first range G1 to the second range G2 may maintain ON of the communication status, ON of detection of the state of the cutting tool 21, and OFF of detection of the position. The wireless communication apparatus 5 may use setting of the communication status of the right-side wireless communication sensor 9 to ON as a trigger to transmit a signal (first data) for setting the communication status to OFF to the left-side wireless communication sensor 9 as indicated by an arrow Ar3.

When setting of the communication status to ON is used as a trigger, the fact that the communication status is set to ON may be used as a trigger or reception of a request for setting the communication status to ON (an event before being completely set to ON) may be used as a trigger. Hereinafter, similarly, in the case where, for example, setting the communication status or detection with the sensor 27 to ON or OFF is used as a trigger, completion of a shift to ON or OFF may be used as a trigger or an event before that may be used as a trigger.

After that, as shown in FIG. 6D, the left-side wireless communication sensor 9 may use reception of first data indicated by the arrow Ar3 in FIG. 6C as a trigger to set the communication status to OFF, may set detection of the state of the cutting tool 21 to OFF, and may set detection of the position to ON. Here, the fact that communication is disconnected may be indicated by not drawing the line Ln1 or the arrow Ar1 in FIG. 6C.

Any one of a process for setting the communication status to OFF, a process for setting detection of the state of the cutting tool 21 to OFF, and a process for setting detection of the position to ON may be started first. Any one of the processes may be started on condition that another process is started or completed. In other words, reception of the first data (arrow Ar3) may be an indirect trigger to start various processes. For example, completion of a process of setting the communication status to OFF (for example, disconnection of communication) may be a trigger to start a process of setting detection of the position to ON.

(Details of First Data)

The first data indicated by the arrow Ar3 in FIG. 6C may be an explicit request or may be an implicit request to set the communication status to OFF.

Examples of the explicit request to set the communication status to OFF may include the one defined as data (signal) to make a request to set the communication status to OFF in a communication standard. In this case, for example, when the wireless communication sensor 9 receives first data, the wireless communication sensor 9 may basically start a process in accordance with a procedure defined in the communication standard and may set the communication status to OFF. In other words, first data in this case may be generally regarded as a request to set the communication status to OFF (disconnection or the like). The explicit request to set the communication status to OFF is not limited thereto and may be, for example, data (signal) uniquely defined by a maker of an apparatus or system.

Examples of the implicit request to set the communication status to OFF may include the one not in compliant with the communication standard. In this case, for example, the wireless communication sensor 9 may be able to recognize that another wireless communication sensor 9 is located in the first range G1, in other words, the position of the wireless communication sensor may shift into the second range G2, by receiving first data. After that, whether to set the communication status to OFF, the timing to set the communication status to OFF, and the like may be set at the discretion of the wireless communication sensor 9. When the communication status is set to OFF, for example, a request to set the communication status to OFF (for example, in compliant with the communication standard) may be sent from the wireless communication sensor 9 to the wireless communication apparatus 5.

(Flowchart)

An example of a flowchart showing the procedure of a process for implementing the operation of the sensor system 1 of which the outline is described above will be described below. The flowchart that will be described below may be drawn so as to be easy to conceptually grasp the procedure of the process and does not always accurately reflect an actual procedure.

(Main Process of Wireless Communication Sensor)

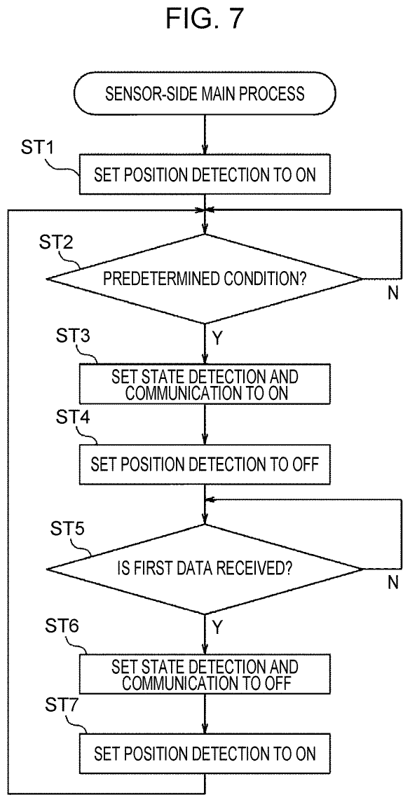

FIG. 7 may be a flowchart showing an example of the outline of the procedure of a main process to be executed by the controller 31 of the wireless communication sensors 9. This process may be executed, for example, in a period of time during which at least the machine tool 3 is in operation.

In step ST1, the controller 31 may detect the position of the wireless communication sensor as part of an initial operation. Detection of the position here may be, for example, only detection of the position once or detection of the position repeatedly at intervals of a certain period (first period). However, in the description of the present embodiment, basically the latter may be taken as an example. In step ST1, it may be assumed that periodical detection of the position is started.

In step ST2, the controller 31 may determine whether the detected position of the wireless communication sensor satisfies a predetermined condition. The predetermined condition may include, for example, a condition that the position of the wireless communication sensor is located within the first range G1. Then, when the determination is affirmative, the controller 31 may proceed to step ST3. When the determination is negative, the controller 31 may repeat step ST2 (waits until the predetermined condition is satisfied) in accordance with the position continuously detected.

In step ST3, the controller 31 may set detection of the state of the cutting tool 21 to ON and may set the status of wireless communication in the wireless communication module 29 to ON. In step ST4, detection of the position may be set to OFF. Step ST3 and step ST4 may correspond to the operation of the wireless communication sensor 9 on the right-hand side of the sheet of FIG. 6B and FIG. 6C. The order of step ST3 and step ST4 may be reversed.

In step ST5, the controller 31 may determine whether first data (the arrow Ar3 of FIG. 6C) is received. The controller 31 may proceed to step ST6 when the determination is affirmative and may repeat step ST5 (waits until first data is received) when the determination is negative.

In step ST6, the controller 31 may set detection of the state of the cutting tool 21 to OFF and may set the status of wireless communication in the wireless communication module 29 to OFF. In step ST7, detection of the position may be set to ON. For example, detection of the position at intervals of the first period may be started. Step ST6 and step ST7 may correspond to the operation of the wireless communication sensor 9 on the left-hand side of the sheet of FIG. 6D. The order of step ST6 and step ST7 may be reversed.

After that, the controller 31 may return to step ST2.

(Main Process of Wireless Communication Apparatus)

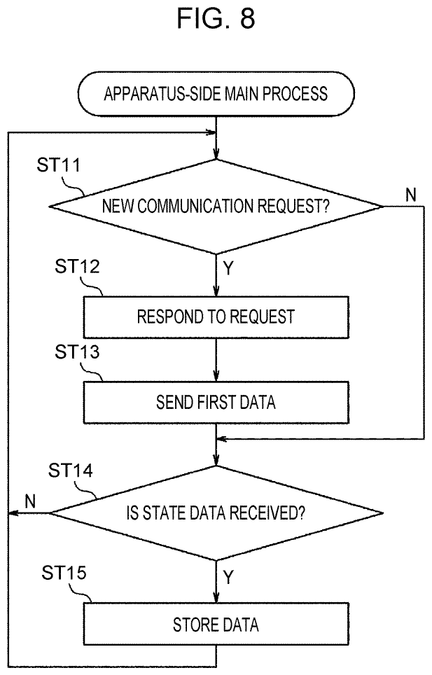

FIG. 8 may be a flowchart showing an example of the outline of the procedure of a main process to be executed by the control unit 17 of the wireless communication apparatus 5. This process may be executed, for example, in a period of time during which at least the machine tool 3 is in operation.

In step ST11, the control unit 17 may determine whether there is a request to set the communication status to ON from the wireless communication sensor 9. Depending on a specific mode of ON and OFF of the communication status, data for which whether it is received is determined may be not a request to set the communication status to ON but data to implicitly inform that the communication status is set to ON. However, in the description of the present embodiment, basically a mode in which data is a request to set the communication status to ON may be taken as an example.

When the control unit 17 makes affirmative determination in step ST11, the control unit 17 may proceed to step ST12. A situation in which the determination is affirmative may correspond to a situation in which a request indicated by the line Ln2 is sent to the wireless communication apparatus 5 in FIG. 6B. When the determination is negative, the control unit 17 may skip step ST12 and step ST13 and may proceed to step ST14.

In step ST12, the control unit 17 may execute a process to respond to the request of step ST11. Thus, as indicated by the line Ln3 in FIG. 6C, the communication status between the wireless communication sensor 9, which is the source of the request, and the wireless communication apparatus 5 may be set to ON.

In step ST13, the control unit 17 may send first data (the arrow Ar3 in FIG. 6C) to the wireless communication sensor 9 of which the communication status has been set to ON before the wireless communication sensor 9 of which the communication status is set to ON in the preceding step ST12. When there is no applicable wireless communication sensor 9 (when, for example, the machine tool 3 starts operation), step ST13 may be skipped. The order of step ST12 and step ST13 may be reversed.

In step ST14, the control unit 17 may determine whether data including a detection result of the state of the cutting tool 21 is received from the wireless communication sensor 9 of which the communication status is ON. When the determination is affirmative, the control unit 17 may proceed to step ST15. When the determination is negative, the control unit 17 may return to step ST11.

In step ST15, the control unit 17 may cause the storage unit 19 to store information on the state of the cutting tool 21, included in the received data. After that, the control unit 17 may return to step ST11.

Here, for the sake of easy understanding, step ST11 to step ST13 and step ST14 to step ST15 may be executed in series, and both may be executed at intervals of the same period. Actually, these steps may be executed in parallel and/or may be respectively executed at intervals of periods different from each other. This may be because, generally, a period to detect the state of the cutting tool 21 is shorter than an interval at which the cutting tool 21 used for cutting is replaced by rotating the turret 23.

As is understood from FIG. 6C, after the first data is sent, data indicating the state of the cutting tool 21 may be sent from the wireless communication sensor 9 of which the communication status is newly set to ON to the wireless communication apparatus 5, and data indicating the state of the cutting tool 21 may also be sent from the wireless communication sensor 9, which is a destination to send first data, to the wireless communication apparatus 5. The wireless communication apparatus 5 may store data indicating the states of both in the storage unit 19. Of course, at the time of storage, data may be classified according to the source wireless communication sensor 9.

(Condition Determination)

In step ST2 of FIG. 7, it may be determined whether the position of the wireless communication sensor falls within the first range G1 in accordance with one detection result of the position of the wireless communication sensor or it may be determined whether the position of the wireless communication sensor falls within the first range G1 over a predetermined period of time (first time) in accordance with the repeatedly detected positions of the wireless communication sensor. Hereinafter, a flowchart according to the latter one example will be described.

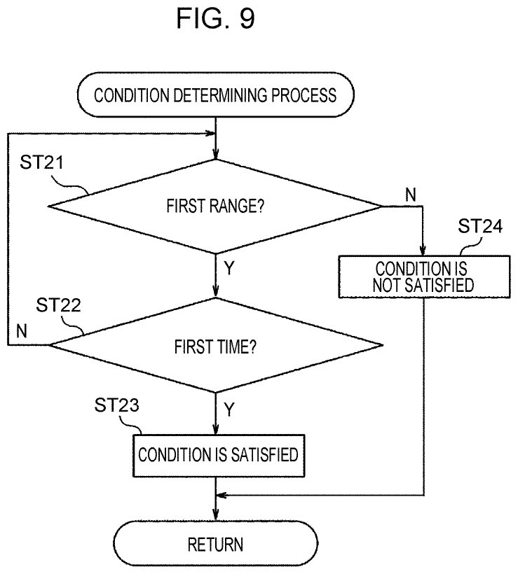

FIG. 9 may be a flowchart showing an example of the procedure of a process to be executed in step ST2 of FIG. 7.

In step ST21, the controller 31 may determine whether the position of the wireless communication sensor falls within the first range G1. The position of the wireless communication sensor to be used for determination at this time may be, for example, a position detected just before step ST21 out of the positions repeatedly detected at intervals of the first period. When the determination is affirmative, the controller 31 may proceed to step ST22. When the determination is negative, the controller 31 may proceed to step ST24.

In step ST22, the controller 31 may determine whether the first time has elapsed from when the condition determining process shown in FIG. 9 is started. An example of the specific length of the first time will be described later. When the determination is negative, the controller 31 may return to step ST21. When the determination is affirmative, the controller 31 may proceed to step ST23.

In step ST23, the controller 31 may determine that the predetermined condition discussed in step ST2 is satisfied. Examples of the specific process may include setting a flag indicating that the predetermined condition is satisfied.

On the other hand, in step ST24, the controller 31 may determine that the predetermined condition discussed in step ST2 is not satisfied. Examples of the specific process may include not setting a flag indicating that the predetermined condition is satisfied (no process needs to be executed).

As described above, in the example of FIG. 9, when the state where the position of the wireless communication sensor falls within the first range G1 is maintained over the first time, it may be determined that the predetermined condition is satisfied, and then the process to set the communication status to ON (step ST3 of FIG. 7) or the like is executed. With this configuration, for example, the likelihood to erroneously identify the cutting tool 21 used for cutting may be reduced. More specifically, the details may be as follows.

When the cutting tool 21 used for cutting is replaced by rotating the turret 23, the cutting tool 21 to be subsequently used for cutting may not be always the cutting tool 21 next to the cutting tool 21 used for cutting till then and can be the cutting tool 21 separated across another cutting tool 21. In this case, during times until the cutting tool 21 to be subsequently used for cutting is located in the first range G1, the other cutting tool 21 may pass through the first range G1. When the fact that the state of being located in the first range G1 has been continued for the first time is used as a condition to make affirmative determination in step ST2, the likelihood that another cutting tool 21 that just passes through the first range G1 is erroneously identified as the cutting tool 21 to be subsequently used for cutting may be reduced.

From the viewpoint of the above advantageous effect, the first time may be, for example, set so as to be longer than a time needed for the turret 23 to rotate an angle corresponding to the first range G1. From the viewpoint of using detection results (two or more detection results) of the position of the wireless communication sensor, repeatedly detected at intervals of the first period, the first time may have a length longer than or equal to twice as long as the first period.

(Modification of Start of Position Detection)

In the description of step ST7 of FIG. 7, the start of detection of the position at intervals of the first period may be discussed. However, detection of the position at intervals of the first period does not need to be started immediately after a trigger event (for example, the process in which the communication status is set to ON in step ST6) occurs. For example, detection of the position at intervals of the first period may be started after a trigger event occurs and when a predetermined period of time (second time) elapses and/or may be started when acquired information does not satisfy the first condition. Hereinafter, a flowchart according to that example will be described.

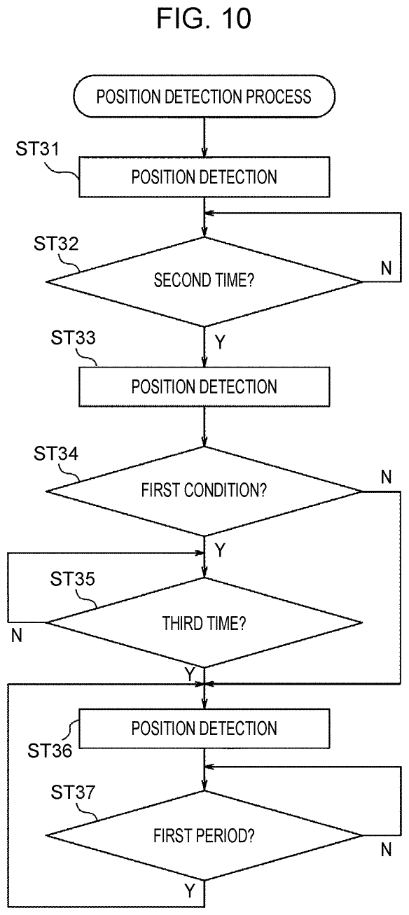

FIG. 10 may be a flowchart showing an example of the procedure of a process to be executed in step ST7 of FIG. 7.

In step ST31, the controller 31 may cause the sensor 27 (27A or 27B) to detect the position of the wireless communication sensor. The detection may be not periodic but only once.

In step ST32, the controller 31 may determine whether the second time has elapsed. An example of the specific length of the second time will be described later. The controller 31 may proceed to step ST33 when the determination is affirmative. The controller 31 may repeat step ST32 (waits until the second time elapses) when the determination is negative.

In step ST33, the controller 31 may cause the sensor 27 (27A or 27B) to detect the position of the wireless communication sensor again. The detection may be not periodic but only once.

In step ST34, the controller 31 may determine whether the acquired information (for example, information on the position of the wireless communication sensor) satisfies the first condition. A specific example of the first condition will be described later. The controller 31 may proceed to step ST35 when the determination is affirmative. The controller 31 may skip step ST35 and may proceed to step ST36 when the determination is negative.

In step ST35, the controller 31 may determine whether a third time has elapsed. An example of the specific length of the third time will be described later. The controller 31 may proceed to step ST36 when the determination is affirmative. The controller 31 may repeat step ST35 (waits until the third time elapses) when the determination is negative.

Step ST36 and step ST37 may represent a process to detect the position at intervals of the first period. Specifically, in step ST36, the controller 31 may acquire a detected value on the position of the wireless communication sensor from the sensor 27 (27A or 27B). In step ST37, the controller 31 may determine whether the first period has elapsed from the last detection of the position of the wireless communication sensor. The controller 31 may return to step ST36 when the determination is affirmative. The controller 31 may repeat step ST37 (waits until the first period elapses) when the determination is negative.

In step ST31 and step ST33, for example, electric power may be supplied to the sensor 27 (27A or 27B) (the sensor 27 is driven) only at the time of detection of the position. On the other hand, detection in step ST37 may be, for example, obtaining a detected value by supplying electric power to (driving) the sensor 27 only at this time or holding (for example, causing the RAM or the like to store) a detected value only at this time from the sensor 27 to which electric power is continuously supplied.

As described above, when detection of the position at intervals of the first period is started on condition that the second time has elapsed, it may be possible to, for example, reduce the likelihood that electric power is consumed by unnecessary detection of the position. Specifically, the details may be as follows. The process of the controller 31 may proceed to step ST7, and the timing at which the process shown in FIG. 10 is started may be regarded as timing at which another cutting tool 21 different from the cutting tool 21 to which the controller 31 executing the process belongs is in a state of being used for cutting. After that, cutting with the other cutting tool 21 will be performed, so there may be a low likelihood that the cutting tool 21 that has started the process shown in FIG. 10 immediately returns to the first range G1. Therefore, by not detecting the position of the wireless communication sensor in such a period of time (second time) during which there is a low likelihood that the cutting tool 21 falls within the first range G1, it may be possible to, for example, reduce an electric power consumption.

When the first condition is satisfied, detection of the position at intervals of the first period may be started after a lapse of the third time. Thus, it may be possible to, for example, reduce an electric power consumption as in the case of the above. In light of the advantageous effect, the first condition may be, for example, a condition to identify a situation in which there is a low likelihood that the cutting tool 21 executing the process shown in FIG. 10 is positioned to the first range G1.

An example of the first condition may include a condition that the position of the wireless communication sensor, detected in step ST31, and the position of the wireless communication sensor, detected in step ST33, can be regarded as the same position. In other words, an example of the first condition may include a condition that it may be regarded as no change in the position of the wireless communication sensor between before a beginning of the second time and after a lapse of the second time.

When there is no change in the position of the wireless communication sensor between before a beginning of the second time and each time of a lapse of the second time, it can be estimated that, for example, the type of machining with another cutting tool 21 currently used for cutting needs a longer time. By starting detection of the position at intervals of the first period after a lapse of the third time, it may be possible to reduce the likelihood that unnecessary detection of the position is performed. In light of such an advantageous effect, the third time may be, for example, a time close to a time for the type of long-time machining that can occur in the machine tool 3.

Another example of the first condition may be a condition that, on the assumption that replacement of the cutting tool 21 is performed in order of arrangement around the rotation axis R1, a change (a variation in angle) in the position of the wireless communication sensor between before a beginning of the second time and after a lapse of the second time is less than or equal to a predetermined amount. On the assumption that replacement of the cutting tool 21 is performed in order of arrangement around the rotation axis R1, another example may be a condition that the position of the wireless communication sensor after a lapse of the second time falls within a predetermined range.

A flowchart extracting only step ST36 and step ST37 may be an example of the flowchart in the case where detection of the position is immediately started in step ST7. Alternatively, step ST31 and step ST33 to step ST35 may be omitted, and detection of the position at intervals of the first period may be started after a lapse of the second time. Step ST31 and step ST33 may be processes that are executed when the first condition includes a condition to perform determination by using the position before a beginning of the second time and the position after a lapse of the second time, and are not required when such a detected result of the position is not used in the first condition. After the determination is affirmative in step ST35, the process may return to step ST34, and determination as to the first condition and waiting for the third time may be repeated.

(Sending after Reception of First Data)

It has been already discussed that, after first data (the arrow Ar3 in FIG. 6C, step ST5 of FIG. 7, and step ST13 of FIG. 8) is received by the wireless communication sensor 9, timing at which the communication status is set to OFF, or the like, may be set as needed. Here, a flowchart on an example of a mode in which, after first data is received, data including a detected result of the state of the cutting tool 21 is sent from the wireless communication sensor 9 to the wireless communication apparatus 5 will be described.

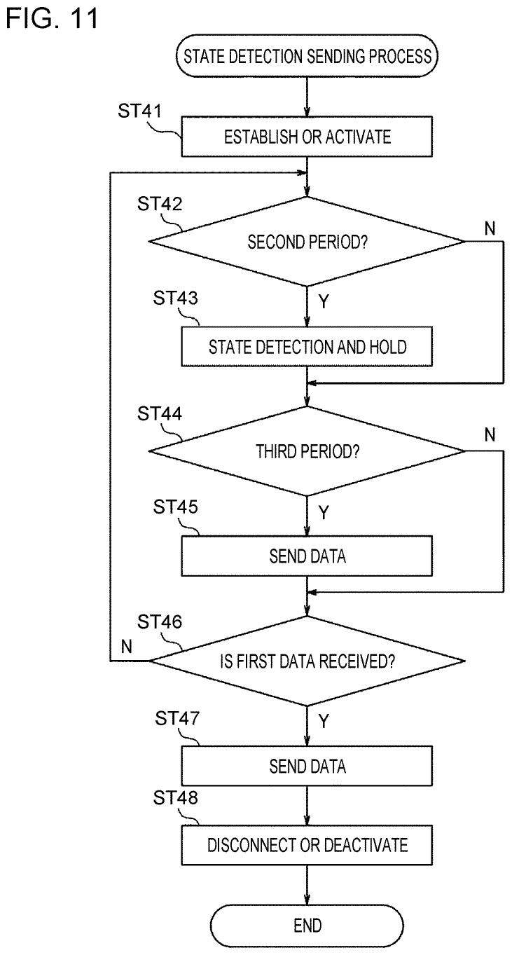

FIG. 11 may be a flowchart showing an example of the procedure of a process on detection of the state of the cutting tool 21 and sending of data including the detection result, out of a process to be executed by the controller 31. The drawing may correspond to step ST3, step ST5, and step ST6 of FIG. 7.

In step ST41, the controller 31 may establish or may activate wireless communication. In other words, the controller 31 may control the wireless communication module 29 such that the communication status is set to ON. However, depending on a mode of activation, an increase in communication traffic due to the fact that detection of the state of the cutting tool 21 with the sensor 27 (27A or 27C) is set to ON may be regarded as activation and, in this case, any particular process may not need to be performed in step ST41.

Step ST42 and step ST43 may be processes to detect the state of the cutting tool 21 at intervals of a certain sampling period (second period).

Specifically, in step ST42, the controller 31 may determine whether the second period has elapsed from a time point at which step ST43 is executed last time (when step ST43 is not executed once, an appropriate time point, for example, just after execution of step ST41). The controller 31 may proceed to step ST43 when the determination is affirmative. The controller 31 may skip step ST43 and may proceed to step ST44 when the determination is negative.

In step ST43, the controller 31 may hold (for example, holds in the RAM or the like) a detected value of a physical quantity on the state of the cutting tool 21 from the sensor 27 (27A or 27C). The process may be, for example, obtaining a detected value by supplying electric power to (driving) the sensor 27 only at this time or holding a detected value only at this time from the sensor 27 to which electric power is continuously supplied.

The length of the second period may be set as needed according to the purpose of detection and/or the type or the like of a physical quantity to be detected. The second period may be different from the first period to detect the position of the wireless communication sensor and may be, for example, shorter than the first period.

Step ST44 and step ST45 may be processes to send data including a detected result on the state of the cutting tool 21 at intervals of a certain period (third period).

Specifically, in step ST44, the controller 31 may determine whether the third period has elapsed from a time point at which step ST45 is executed last time (when step ST45 is not executed once, an appropriate time point, for example, just after execution of step ST41). The controller 31 may proceed to step ST45 when the determination is affirmative. The controller 31 may skip step ST45 and may proceed to step ST46 when the determination is negative.

In step ST45, the controller 31 may control the wireless communication module 29 such that the detected value held in step ST43 is sent to the wireless communication apparatus 5. Here, in the example shown in FIG. 11, the third period may have, for example, a length longer than or equal to twice as long as the second period. Therefore, the controller 31 may execute step ST43 twice or more by the time step ST45 is executed. In other words, the controller 31 may accumulate two or more detected values. In step ST45, the controller 31 may send data including the accumulated detected values.

Different from the illustrated example, data including a detected value may be sent at intervals of the second period. For example, step ST44 may be omitted, and step ST45 may be incorporated into step ST43. Sending of data including a detected value may be performed irregularly and independently of (asynchronous with) data acquisition from the sensor 27.

Step ST46 may be similar to step ST5 of FIG. 7. In other words, the controller 31 may determine whether first data is received. The controller 31 may proceed to step ST47 when the determination is affirmative. The controller 31 may return to step ST42 when the determination is negative. Because the process returns to step ST42, detection at intervals of the second period and sending at intervals of the third period may be repeated until first data is received.

In step ST47, when there is any detected value detected and held in step ST43 and not sent in step ST45, the controller 31 may send data including the detected value. Such an unsent detected value may occur due to, for example, the fact that the third period is longer than the second period.

In step ST48, the controller 31 may disconnect or may deactivate wireless communication. In other words, the controller 31 may control the wireless communication module 29 such that the communication status is set to OFF. However, as in the case of step ST41, depending on a mode of deactivation, any particular process does not need to be executed in step ST48.

In the above-described first example, the length of the first time, the size of the first range, the presence or absence and length of the second time, the presence or absence of the first condition and its details, the length of the third time, the length of the second period, the length of the third period, and the like may be the same among the wireless communication sensors 9 or may be varied from each other. These values may be set by a manufacturer of the sensor system 1 or may be set by a user of the sensor system 1.

(Second Example of Trigger to Change Communication Status and Others)

Hereinafter, an example (second example) different from the first example in which a trigger or the like to change the communication status and the like, described with reference to FIG. 6A to FIG. 11, will be described. Hereinafter, basically, portions different from those of the first example will be discussed. Matters not specifically referred to may be similar to those of the first example or may be inferred from analogy.

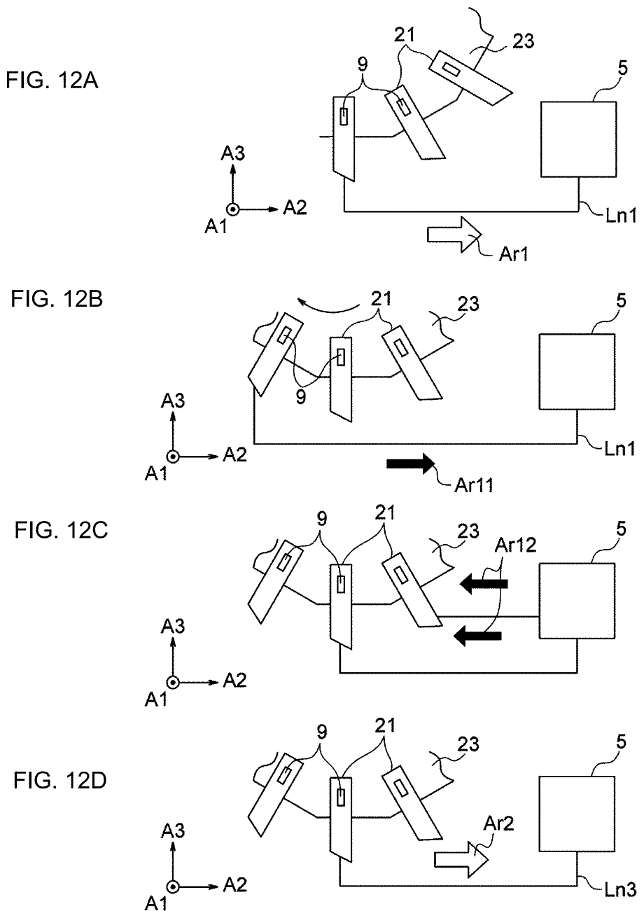

FIG. 12A to FIG. 12D may be schematic views for illustrating the outline of a trigger to change the communication status and the like.

In these drawings, part of the base 7 and the wireless communication apparatus 5 may be shown. As for the base 7, more specifically, three cutting tools 21 side by side with each other in a direction along the outer periphery of the turret 23 may be shown. Here, as shown in FIG. 12A, the case where the cutting tool 21 on the left-hand side of the sheet is used for cutting (positioned in the first range G1) and then, as shown in FIG. 12B to FIG. 12D, the cutting tool 21 on the center of the sheet is used for cutting may be taken as an example.

In FIG. 12A, the state of the cutting tool 21 at a location (first range G1) at which the cutting tool 21 is used for cutting may be similar to that in FIG. 6A. In other words, the communication status may be set to ON, detection of the state of the cutting tool 21 may be set to ON, and detection of the position may be set to OFF.

In FIG. 12A, in the cutting tool 21 at a location (second range G2) at which the cutting tool 21 is not used for cutting, the communication status may be set to OFF, and detection of the state of the cutting tool 21 may be set to OFF. This may be similar to FIG. 6A. However, different from FIG. 6A, for the cutting tool 21 in the second range G2, detection of the position may also be set to OFF. In other words, in the cutting tool 21 in the second range G2, periodic detection of the position may not be performed.

A state where detection of the position is not performed in the cutting tool 21 in the second range G2 may be a state due to the fact that the process of performing periodical detection of the position is not intended from the beginning. In other words, this may be due to the fact that step ST36 and step ST37 are not incorporated in the process in which the controller 31 continuously executes over a period of time during which the wireless communication sensor 9 is located in the second range G2. A state where detection of the position is not performed in the cutting tool 21 in the second range G2 may be an accidentally occurred state as a result of setting the already-described second time (step ST32) and third time (step ST35) although the process of performing periodical detection of the position is intended. In the following description, basically, the former may be taken as an example.

As shown in FIG. 12B, the machine tool 3 may rotate the turret 23 such that the cutting tool 21 on the center of the sheet is located in the first range G1. At this time, the wireless communication apparatus 5 may detect that there is a possibility that the cutting tool 21 has been replaced. Various methods as will be described later may be used as the replacement method. Here, a mode in which predetermined data is sent from the wireless communication sensor 9 on the left-hand side of the sheet, shifted from the first range G1 to the second range G2, as indicated by an arrow Ar11, to the wireless communication apparatus 5 may be illustrated. In the wireless communication sensor 9 on the left-hand side of the sheet, various methods as will be described later may also be used as a method to detect a shift of the position of the wireless communication sensor from the first range G1 to the second range G2.

After that, as indicated by an arrow Ar12 in FIG. 12C, the wireless communication apparatus 5 may send data to provide an instruction to the other wireless communication sensors 9 other than the wireless communication sensor 9 shifted from the first range G1 to the second range G2 to detect the position. Depending on the mode of OFF of the communication status, the wireless communication apparatus 5 may execute a process for setting the communication status with the other wireless communication sensors 9 to not OFF in advance of sending of data. For example, when OFF of the communication status is a state where communication is disconnected, communication may be established. When OFF of the communication status is an inactive state where communication traffic is lower than the level at which an instruction to detect the position can be sent and received, the level may be raised.

The wireless communication sensor 9 instructed to detect the position may detect the position of the wireless communication sensor. Thus, the wireless communication sensor 9 may be able determine whether the position of the wireless communication sensor falls within the first range G1. As shown in FIG. 12D, the wireless communication sensor 9 of which the position is determined to fall within the first range G1 may set the communication status to ON and may set detection of the state of the cutting tool 21 to ON. Here, an operation to set the communication status to ON may be due to the fact that detection of the state of the cutting tool 21 is set to ON as already described. On the other hand, the wireless communication sensor 9 of which the position is determined not to fall within the first range G1 may set the communication status to OFF and may set detection of the state of the cutting tool 21 to OFF (maintains the OFF state).

An instruction to detect the position of the wireless communication sensor (the arrow Ar12 in FIG. 12C) may be sent to, for example, all the other wireless communication sensors 9 other than the wireless communication sensor 9 shifted from the first range G1 to the second range G2. In the following description, basically, this mode may be taken as an example. However, in accordance with appropriate information (for example, information on the position of the wireless communication sensor 9 shifted from the first range G1 to the second range G2), the wireless communication sensor 9 that is highly likely to be located in the first range G1 may be identified, and data may be sent to only some of the other wireless communication sensors 9. Alternatively, data may be sent to all the wireless communication sensors 9 including the wireless communication sensor 9 shifted from the first range G1 to the second range G2.

(Main Process of Wireless Communication Sensor)

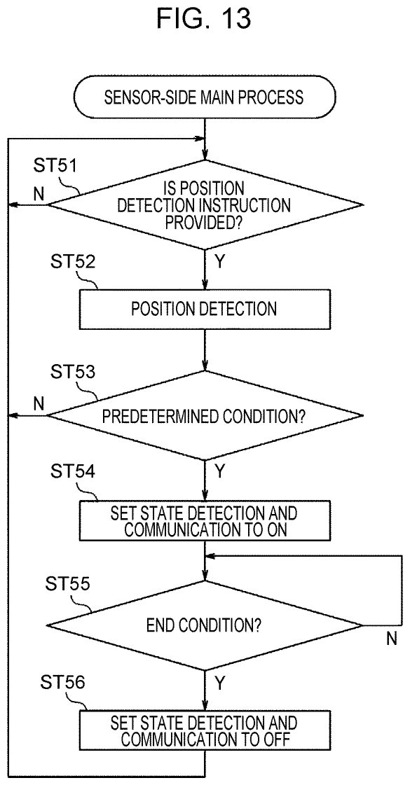

FIG. 13 may be a flowchart showing an example of the outline of the procedure of a main process to be executed by the controller 31 of the wireless communication sensor 9 in order to implement the operation of the second example. This process may correspond to FIG. 7 of the first example and may be executed, for example, in a period of time during which at least the machine tool 3 is in operation.

In step ST51, the controller 31 may determine whether an instruction to detect the position of the wireless communication sensor (the arrow Ar12 of FIG. 12C) is received. The controller 31 may proceed to step ST52 when the determination is affirmative. The controller 31 may repeat step ST51 (waits until the instruction is received) when the determination is negative. As already discussed, depending on the mode of OFF of the communication status, a process for setting the communication status to not OFF may be executed before the determination is affirmative.

Step ST52 and step ST53 may be processes similar to step ST1 and step ST2 of FIG. 7. In other words, the controller 31 may determine whether the wireless communication sensor is located in the first range G1. Specifically, for example, in step ST53, the controller 31 may cause the sensor 27 (27A or 27B) to detect the position of the wireless communication sensor or may start detection of the position of the wireless communication sensor at intervals of the first period. In step ST55, it may be determined whether a predetermined condition is satisfied.

The controller 31 may proceed to step ST54 when the determination is affirmative. The controller 31 may return to step ST51 when the determination is negative. Depending on the mode of OFF of the communication status, before returning to step ST51, a process for setting the communication status to OFF may be executed in contrast to the case where the determination is affirmative in step ST51. The operation to proceed to step ST54 may correspond to the operation of the wireless communication sensor 9 on the center of the sheet of FIG. 12C. The operation to return to step ST51 may correspond to the operation of the wireless communication sensor 9 on the right-hand side of the sheet of FIG. 12C.

Detection of the position, shown in step ST52, may be only once. Then, in accordance with the only one detection result, it may be determined in step ST53 whether the position of the wireless communication sensor falls within the first range G1. In step ST52, detection of the position at intervals of the first period may be started, and, as shown in FIG. 9, it may be determined whether the state of being located in the first range G1 has been continued over the first time. In any case, here, for example, after the determination is affirmative in step ST51, the sensor 27 (27A or 27B) may be driven (electric power is supplied) only during times until determination of step ST53 completes.

Step ST54 to step ST56 may be processes corresponding to step ST3, step ST5, and step ST6 of FIG. 7 as a whole.

Specifically, step ST54 may be a process similar to that of step ST3. In other words, in step ST54, the controller 31 may set detection of the state of the cutting tool 21 to ON and may set the status of wireless communication in the wireless communication module 29 to ON. The operation may correspond to the operation of the wireless communication sensor 9 on the center of the sheet of FIG. 12D.

Step ST55 may be a process corresponding to step ST5. In other words, in step ST55, the controller 31 may wait until the determination is affirmative and may maintain detection of the state of the cutting tool 21 and the ON state of the communication status. On the other hand, when the determination is negative, the controller 31 may proceed to step ST56.

Step ST56 may be a process similar to that of step ST6. In other words, in step ST56, the controller 31 may set detection of the state of the cutting tool 21 to OFF and may set the status of wireless communication in the wireless communication module 29 to OFF. Step ST55 and step ST56 may correspond to the operation of the wireless communication sensor 9 on the left-hand side of the sheet of FIG. 12A to FIG. 12C.

The process shown in FIG. 11 may be applied to step ST54 to step ST56 by replacing step ST46 corresponding to step ST5 with step ST55.

In step ST55, different from step ST5, not whether first data is received from the wireless communication apparatus 5 but whether a predetermined end condition is satisfied may be determined. The end condition may be, for example, a condition that correlates with a shift of the wireless communication sensor 9 from the first range G1 to the second range G2.

For example, between when the cutting tool 21 to which the wireless communication sensor 9 belongs is being used for cutting and when not being used for cutting, the size, a change, and/or the like of a physical quantity on the state of the cutting tool 21 may be different. Therefore, the end condition may include a condition that a physical quantity on the detected state of the cutting tool 21 satisfies a predetermined condition. For example, when a state where the detected acceleration or vibration (amplitude) is lower than or equal to a predetermined value has been continued for a predetermined time, it may be determined that the end condition is satisfied.

In the description of FIG. 12B, the operation in which the wireless communication sensor 9 detects a shift of the position of the wireless communication sensor from the first range G1 to the second range G2 and sends predetermined data (the arrow Ar11 in FIG. 12B) to the wireless communication apparatus 5 may be discussed. The detection may be the same as, for example, affirmative determination in step ST55. Then, data (arrow Ar11) may be sent at appropriate timing with respect to a time point at which the determination is affirmative.

The data (arrow Ar11) may be merely data to inform that the position of the wireless communication sensor shifts from the first range G1 to the second range G2 or may be data to make a request of the wireless communication apparatus 5 to set the communication status to OFF in step ST56. Data to set the communication status to OFF, as in the case of the already-described first data (arrow Ar3 of FIG. 6C), may be implicit or may be explicit.

(Main Process of Wireless Communication Apparatus)

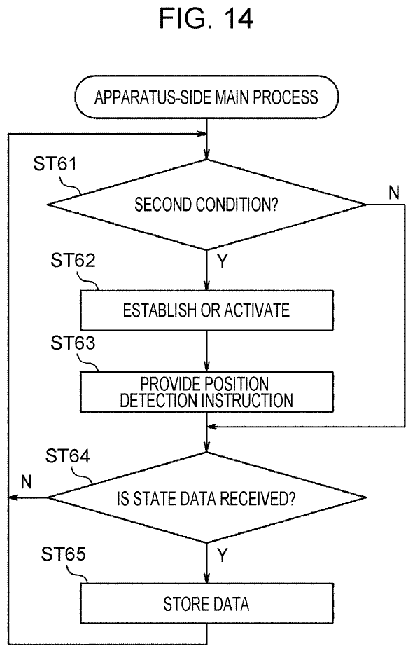

FIG. 14 may be a flowchart showing an example of the outline of the procedure of a main process to be executed by the control unit 17 of the wireless communication apparatus 5 in order to implement the operation of the second example. This process may correspond to FIG. 8 of the first example and may be executed, for example, in a period of time during which at least the machine tool 3 is in operation.

Step ST61 to step ST63 may be processes to determine whether there is the necessity to provide an instruction to detect the position to the wireless communication sensors 9 and, when there is the necessity, provide an instruction to detect the position. The process may correspond to FIG. 12B and FIG. 12C.

Specifically, in step ST61, the control unit 17 may determine whether a predetermined second condition is satisfied. The control unit 17 may proceed to step ST62 when the determination is affirmative. The control unit 17 may skip step ST62 and step ST63 and may proceed to step ST64 when the determination is negative. A specific example of the second condition will be described later.

In step ST62, the control unit 17 may set the communication status to ON with the wireless communication sensors 9 (in the example of FIG. 12C, the wireless communication sensors 9 on the center of the sheet and on the right-hand side of the sheet) to which, for example, it is necessary to provide an instruction to detect the position (which may be located in the first range G1), out of the wireless communication sensors 9. As is already described above, depending on the mode in which the communication status is OFF, or the like, the process may not be needed.

In step ST63, the control unit 17 may send data (the arrow Ar12 in FIG. 12C) for providing an instruction to detect the position to at least one wireless communication sensor 9 that may be located in the first range G1.

As already discussed, when the determination is negative in step ST53 of FIG. 13, the wireless communication sensor 9 may execute a process to set the communication status to OFF. In this case, the control unit 17 of the wireless communication apparatus 5 may execute a process to respond to a request to set the communication status to OFF from the wireless communication sensor 9.

Step ST64 and step ST65 may be similar to step ST14 and step ST15 of FIG. 8. Different from the drawing, step ST64 and step ST65 may be executed in parallel with step ST61 to step ST63 and/or may be executed at intervals of a period different from the period of step ST61 to step ST63, as in the case of FIG. 8.

The second condition of step ST61 may be, for example, a condition that there occurs an event that correlates with a change in the position of the wireless communication sensor 9. The second condition may be useful even when not necessarily connected to such an event. For example, when there is no wireless communication sensor 9 that determines that the position of the wireless communication sensor falls within the first range G1 or, conversely, two or more wireless communication sensors 9 determine that the position of the wireless communication sensor falls within the first range G1, due to any unexpected error, it may be possible to determine the position of the wireless communication sensor by detecting the position of the wireless communication sensor again. From another viewpoint, the second example may be combined with the first example.

The second condition may be, for example, a condition on at least one of data from at least one of the wireless communication sensors 9 and the status of wireless communication with the wireless communication sensors 9.

More specifically, for example, the second condition may include a condition that, as shown in FIG. 12B, from the cutting tool 21 shifted from the first range G1 to the second range G2, data that informs the movement (the arrow Ar11 in FIG. 12A to FIG. 12D) is received. As already discussed, the data may be a request for setting the communication status to OFF. In other words, the second condition may include a condition that the status of the wireless communication of the wireless communication sensor 9 of which the communication status is ON is set to OFF. The condition may be determined to be satisfied on condition that the process to set the communication status to OFF is started or may be determined to be satisfied on condition that the process to set the communication status to OFF is complete.

For example, as discussed in the description of the end condition of step ST55 of FIG. 13, a detected value of a physical quantity on the state of the cutting tool 21 may be different between when the cutting tool 21 is being used for cutting and when the cutting tool 21 is not being used for cutting. Therefore, the second condition, as in the case of the end condition, may include a condition that a detected value of a physical quantity on the state of the cutting tool 21, included in data from the wireless communication sensor 9, satisfies a predetermined condition (third condition).

Other than the above, for example, as already described, the second condition may include a condition that the communication status with all the wireless communication sensors 9 are set to OFF or a condition that the communication status with two or more wireless communication sensors 9 are set to ON.

As described above, in the present embodiment, the sensor system 1 may include the base 7, the wireless communication sensors 9 attached to the base 7, and the wireless communication apparatus 5 that performs wireless communication with the wireless communication sensors 9. The wireless communication sensor 9 may include the sensor 27 (27A or 27B) that detects the position of the wireless communication sensor, the wireless communication module 29 that performs wireless communication with the wireless communication apparatus 5, and the controller 31 that controls the sensor 27 and the wireless communication module 29. The controller 31, when the position of the wireless communication sensor, detected by the sensor 27, satisfies the predetermined condition (the determination is affirmative in step ST2 or step ST53), may change the status of wireless communication between the wireless communication module 29 and the wireless communication apparatus 5 from a first state (OFF) to a second state (ON) in which an electric power consumption of the wireless communication module 29 is greater than in the first state.

Therefore, for example, the wireless communication sensor 9 may be capable of reducing electric power to be consumed by wireless communication in a situation in which the necessity of communication with the wireless communication apparatus 5 is estimated to be low. As a result, for example, it may be possible to reduce running costs for the wireless communication sensor 9. For example, when the wireless communication sensor 9 includes the battery 33, the battery 33 can be reduced in size or the frequency of charge of the battery 33 can be reduced.

In the present embodiment, the predetermined condition (step ST2 or step ST53) may include, for example, a condition that a state in which the position of the wireless communication sensor falls within the first range G1 has continued for a first time (the determination is affirmative in step ST22).

In this case, for example, as discussed in the description of FIG. 9, when the wireless communication sensor 9 temporarily passes through the first range G1, the likelihood to erroneously determine that the wireless communication sensor 9 is positioned in the first range G1 may be reduced.

In the present embodiment, the controller 31, for example, may cause the sensor 27 (27A or 27B) to detect the position of the wireless communication sensor at intervals of the first period (step ST36 and step ST37 in FIG. 10).

In this case, for example, the wireless communication sensor 9, as in the case of the first example described with reference to FIG. 6A to FIG. 6D, may be capable of voluntarily detect a shift from the second range G2 to the first range G1 (regardless of an instruction from the wireless communication apparatus 5). In this case, for example, depending on the length of the first period, as compared to the second example, a shift of the position of the wireless communication sensor from the second range G2 to the first range G1 can be early identified.

In the present embodiment, the controller 31, for example, may stop control to cause the sensor 27 (27A or 27B) to detect the position of the wireless communication sensor at intervals of the first period in response to a change of the status of wireless communication from the first state (OFF) to the second state (ON) (step ST4).

In this case, for example, in the wireless communication sensor 9 of which the necessity to detect the position is low, it may be possible to reduce electric power to be consumed by detection of the position. For example, it may be highly likely that the wireless communication sensor 9 of the cutting tool 21 being used for cutting provides an error in detection of the position, caused by vibration or the like generated due to cutting. It may be reasonable to stop detection of the position in such a situation.

In the present embodiment, for example, the combined sensor 27A (FIG. 4A) that is an example of the sensor that detects the position may be any one of an acceleration sensor and a geomagnetic sensor. The controller 31 may cause the combined sensor 27A to detect a vibration state as the state of the base 7 at intervals of the second period different from the first period (step ST42 and step ST43).

In other words, the sensor 27 may be used as both detection of the position and detection of the state. In this case, for example, size reduction and cost reduction of the wireless communication sensor 9 may be easy.

In the present embodiment, for example, the wireless communication sensor 9B (FIG. 4B) may include the state sensor 27C that is an example of a second sensor in addition to the position sensor 27B that is an example of a sensor that detects the position. The controller 31 may cause the state sensor 27C to detect the state of the base 7 at intervals of the second period different from the first period.

In this case, for example, the state of the base 7 to be detected is not limited to a vibration state, and the application range of the wireless communication sensor 9 may expand. When the state sensor 27C is the one that detects a physical quantity similar to that in detection of the position (for example, an acceleration sensor or a geomagnetic sensor), the position sensor 27B and the state sensor 27C may be respectively appropriate for detection of the position and vibration state, with the result that detection accuracy is improved.

In the present embodiment, the controller 31, for example, may stop driving of the wireless communication module 29 (see step ST6 and step ST7) in at least part of a period of time during which the sensor 27 (27A or 27B) is caused to detect the position of the wireless communication sensor at intervals of the first period. In other words, supply of electric power may be stopped.

In this case, for example, in comparison with the case where wireless communication is deactivated, it may be possible to reduce electric power to be consumed by wireless communication. In a mode in which the position of the wireless communication sensor is detected at intervals of the first period, as is already discussed, it may be possible to early detect a shift of the position of the wireless communication sensor from the second range G2 to the first range G1, so it may be possible to compensate for a delay due to a time needed to start driving of the wireless communication module 29.

In the present embodiment, for example, in the first state (OFF), wireless communication with the wireless communication apparatus 5 may be disconnected, and, in the second state (ON), wireless communication with the wireless communication apparatus 5 may be established.

In this case, for example, it may be possible to reduce an electric power consumption as much as possible when the communication status is OFF.

In the present embodiment, for example, in the first state (OFF), wireless communication with the wireless communication apparatus 5 may be established, but communication traffic per unit time may be lower than in the second state (ON).

In this case, for example, it may be possible to quickly change the communication status from OFF to ON. By extension, for example, it may be possible to send data in time for the start of machining.

In the present embodiment, the wireless communication apparatus 5, in response to a change of the status of wireless communication of any one of the wireless communication sensors 9 from the first state (OFF) to the second state (ON), may send first data to another one of the wireless communication sensors 9 of which the status of wireless communication is already the second state (step ST13).

In this case, for example, the wireless communication sensor 9 that shifts from the first range G1 to the second range G2 does not need to detect the shift into the second range G2 by itself. As a result, for example, it may be more likely to allow detection of the position of the wireless communication sensor in the first range G1 to be set to OFF. In addition, for example, the likelihood that the wireless communication sensor 9 not in the first range G1 erroneously keeps ON of the communication status may be reduced.

In the present embodiment, the first data (step ST13) may be, for example, data to provide an instruction to change the communication status from the second state (ON) to the first state (OFF).

In this case, for example, a request for setting the communication status to OFF is able to be used as first data, so it may be possible to simplify the procedure to set the communication status to OFF. By extension, it may be possible to reduce a load of communication.

In the present embodiment, the controller 31, for example, after the controller 31 receives first data, may cause the wireless communication module 29 to send data including a detection result on the state of the base 7 before the status of wireless communication becomes the first state (OFF) (step ST47).

In this case, for example, as discussed in the description of FIG. 11, when there is an unsent detected value at the time when first data is received, it may be possible to send data including the detected value. Thus, it may be possible to reduce the likelihood that the acquired detected value is useless. From another viewpoint, this may be regarded as saving of an electric power consumption on accumulation of data for the state of the base 7.

In the present embodiment, the controller 31, for example, may start control to cause the sensor 27 (27A or 27B) to detect the position of the wireless communication sensor at intervals of the first period in response to a change of the status of wireless communication to the first state (OFF) (see step ST6 and step ST7).

In this case, for example, the wireless communication sensor 9 may continuously detect the position of the wireless communication sensor from when the communication status is set to OFF. Detection of the position of the wireless communication sensor may be, as already discussed, used for whether a predetermined condition for setting the communication status to ON is satisfied. Therefore, for example, it may be possible to detect the position of the wireless communication sensor relatively without omission over a period of time during which the communication status is OFF and reliably detect a situation in which the communication status should be set to ON.

In the present embodiment, the controller 31, when, for example, the status of wireless communication becomes the first state (OFF), may start control to cause the sensor 27 (27A or 27B) to detect the position of the wireless communication sensor at intervals of the first period after a lapse of the second time (for example, a mode in which step ST31, and step ST33 to step ST35 are omitted in FIG. 10).

In this case, for example, as discussed in the description of FIG. 10, on the assumption that there is a low likelihood of a shift into the first range G1 just after a shift into the second range G2, it may be possible to reduce the likelihood that the position is detected in a period of time during which the likelihood of a shift into the first range G1 is low. As a result, it may be possible to reduce an electric power consumption.

In the present embodiment, the controller 31 may detect the position of the wireless communication sensor after a lapse of the second time (step ST33), and, when the position of the wireless communication sensor satisfies the first condition (affirmative determination in step ST34), may start control to cause the sensor 27 (27A or 27B) to detect the position of the wireless communication sensor at intervals of the first period after a lapse of the third time (step ST35 to step ST37).

In this case, as discussed in the description of FIG. 10, it may be possible to reduce the likelihood that the position is detected in a period of time during which the likelihood of a shift into the first range G1 is low in accordance with various assumptions. As a result, it may be possible to reduce an electric power consumption.

In the present embodiment, the controller 31, for example, may detect the position of the wireless communication sensor in response to a change of the status of wireless communication to the first state (OFF) (step ST31) and may further detect the position of the wireless communication sensor after a lapse of the second time (step ST33). The first condition (step ST34) may include a condition that there is no change in the position of the wireless communication sensor between before a beginning of the second time and after a lapse of the second time.

In this case, as discussed in the description of FIG. 10, it may be possible to reduce the likelihood that the position is detected in a period of time during which the likelihood of a shift into the first range G1 is low in accordance with the assumption that the duration of the status quo is long. As a result, it may be possible to reduce an electric power consumption.

In the present embodiment, the wireless communication apparatus 5, when a second condition on at least one of data from at least one of the wireless communication sensors 9 and the status of wireless communication with the wireless communication sensors 9 is satisfied (affirmative determination in step ST61), may send instruction data to at least one of the wireless communication sensors 9 to detect the position of the wireless communication sensor (step ST63).

In this case, for example, the wireless communication sensor 9 may detect the position only when an instruction to detect the position is provided. Thus, for example, in comparison with a mode to detect the position at intervals of the first period, it may be possible to reduce an electric power consumption on detection of the position. For example, as described with reference to FIG. 14, it may be possible to resolve a situation in which the number of the wireless communication sensors 9 of which the position of the wireless communication sensor is determined to fall within the first range G1 is large (for example, two or more) or small (for example, less than one) due to errors.

In the present embodiment, for example, the controller 31, when data detected by the sensor 27 (27A or 27B) that detects the position or another sensor 27 (27C) of the wireless communication sensor satisfies a predetermined end condition (affirmative determination in step ST55), may cause the wireless communication module 29 to change the status of wireless communication from the second state (ON) to the first state (OFF). The second condition (step ST61) for which the wireless communication apparatus 5 determines may include a condition that the status of wireless communication of the wireless communication sensor 9 of which the status of wireless communication is the second state is changed to the first state. The wireless communication apparatus 5 may send the instruction data to another wireless communication sensor 9 other than the wireless communication sensor 9, of which the status of wireless communication is changed to the first state, to detect the position of the wireless communication sensor (step ST63).

In this case, for example, with the wireless communication sensor 9 of which the communication status is set to OFF, notification that the necessity to detect the position arises in another wireless communication sensor 9 may be reliably provided to the wireless communication apparatus 5. Thus, the likelihood of occurrence of a state where an instruction to detect the position is not provided from the wireless communication apparatus 5 although the wireless communication sensors 9 should be caused to detect the position may be reduced. The wireless communication apparatus 5 may be able to use the communication status itself with the wireless communication sensor 9 of which the communication status is set to OFF as a material to determine the presence or absence of the necessity to detect the position. Therefore, the wireless communication sensor 9 may not need to separately send data to inform that there arises the necessity to detect the position from a process for setting the communication status to OFF.

In the present embodiment, the second condition may include, for example, a condition that data indicating a detection result of the state of the base 7 from the wireless communication sensor of which the status of wireless communication is the second state (ON) satisfies a third condition.

In this case, for example, the wireless communication sensor 9 that shifts from the first range G1 to the second range G2 does not need to send data informing that there arises the necessity to detect the position to the wireless communication apparatus 5. Therefore, it may be possible to simplify the process of the wireless communication sensor 9.

In the above-described embodiment, each of the combined sensor 27A and the position sensor 27B may be an example of a sensor. The state sensor 27C may be an example of a second sensor. OFF and ON of the communication status may be examples of a first state and a second state. The machine tool 3 may be an example of a wireless terminal.

The technology according to the present disclosure is not limited to the above-escribed embodiment and may be implemented in various modes.

A machine tool serving as a wireless terminal is not limited to a turning center (lathe). For example, a machine tool may include a main shaft that holds a rotating tool, and an auto tool changer (ATC) that replaces a rotating tool held by the main shaft. In this case, the wireless communication sensor 9 may be, for example, provided in a non-rotating part of the rotating tool. The wireless communication sensor 9 may change the communication status in accordance with the difference between the position at the time when the wireless communication sensor 9 is held by the main shaft and the position at the time when the wireless communication sensor 9 is held by the ATC. A communication terminal is not limited to a machine tool. For example, a communication terminal may be play equipment or toy having a rotatable base.

In the embodiment, the position may be defined as an orientation in the vertical plane; however, the position may be, for example, an orientation in a horizontal plane, may be an orientation in a three-dimensional space, or may be an orientation with respect to an object (member) other than the earth. For example, a magnetic sensor may be capable of detecting the position in a horizontal plane. When a predetermined member that forms a magnetic field is disposed near a base, the magnetic sensor may be capable of detecting the position with respect to the predetermined member.

In the embodiment, the status of wireless communication may be changed to the second state for the main purpose of sending information on the state of the base 7 from the wireless communication sensor 9 to the wireless communication apparatus 5. However, a change to the second state may be performed for the main purpose of sending information from a wireless communication apparatus to a wireless communication sensor. For example, a signal including information for controlling an apparatus to which a wireless communication sensor belongs may be sent from a wireless communication apparatus to a wireless communication sensor.

1. A sensor system comprising:
a base;
one or more wireless communication sensors attached to the base; and
a wireless communication apparatus that performs wireless communication with the wireless communication sensors, wherein
the wireless communication sensors comprises
a sensor that detects a position of the wireless communication sensor,
a wireless communication module that performs wireless communication with the wireless communication apparatus, and
a controller that controls the sensor and the wireless communication module, and
the controller, when the position of the wireless communication sensor, detected by the sensor, satisfies a predetermined condition, may change a status of wireless communication between the wireless communication module and the wireless communication apparatus from a first state to a second state in which an electric power consumption of the wireless communication module is greater than in the first state.

2. The sensor system according to claim 1, wherein
the predetermined condition includes a condition that a state in which the position of the wireless communication sensor falls within a first range continues for a first time.

3. The sensor system according to claim 1, wherein
the controller causes the sensor to detect the position of the wireless communication sensor at intervals of a first period.

4. The sensor system according to claim 3, wherein
the controller stops control to cause the sensor to detect the position of the wireless communication sensor at intervals of the first period in response to a change of the status of wireless communication from the first state to the second state.

5. The sensor system according to claim 3, wherein
the sensor is any one of an acceleration sensor and a geomagnetic sensor, and
the controller causes the sensor to detect a vibration state as the state of the base at intervals of a second period different from the first period.

6. The sensor system according to claim 3, wherein
the wireless communication sensors comprises a second sensor, and
the controller causes the second sensor to detect the state of the base at intervals of a second period different from the first period.

7. The sensor system according to claim 6, wherein
the second sensor is any one of an acceleration sensor, a geomagnetic sensor, an angular velocity sensor, an acoustic emission sensor, a temperature sensor, and a stress strain sensor.

8. The sensor system according to claim 3, wherein
the controller stops driving of the wireless communication module in at least part of a period of time during which the controller is causing the sensor to detect the position of the wireless communication sensor at intervals of the first period.

9. The sensor system according to claim 1, wherein
in the first state, wireless communication with the wireless communication apparatus is disconnected, and
in the second state, wireless communication with the wireless communication apparatus is established.

10. The sensor system according to claim 1, wherein
in the first state, wireless communication with the wireless communication apparatus is established, but communication traffic per unit time is lower than in the second state.

11. The sensor system according to claim 1, wherein
the wireless communication apparatus, in response to a change of the status of wireless communication of any one of the wireless communication sensors from the first state to the second state, sends first data to another one of the wireless communication sensors, of which the status of wireless communication is already the second state.

12. The senor system according to claim 11, wherein
the first data is data to provide an instruction to change the wireless communication status from the second state to the first state.

13. The sensor system according to claim 11, wherein
the controller causes the sensor to detect
the position of the wireless communication sensor at intervals of a first period, and
a vibration state as the state of the base at intervals of a second period different from the first period,
the controller, after the controller receives the first data, causes the wireless communication module to send data including a detection result on the state of the base before the status of wireless communication becomes the first state.

14. The sensor system according to claim 11, wherein
the controller causes the sensor to detect the position of the wireless communication sensor at intervals of a first period,
the controller starts control to cause the sensor to detect the position of the wireless communication sensor at intervals of the first period in response to a change of the status of wireless communication to the first state, and
the controller stops control to cause the sensor to detect the position of the wireless communication sensor at intervals of the first period in response to a change of the status of wireless communication from the first state to the second state.

15. The sensor system according to claim 11, wherein
the controller causes the sensor to detect the position of the wireless communication sensor at intervals of a first period,
the controller, when the status of wireless communication becomes the first state, starts control to cause the sensor to detect the position of the wireless communication sensor at intervals of the first period after a lapse of a second time, and
the controller stops control to cause the sensor to detect the position of the wireless communication sensor at intervals of the first period in response to a change of the status of wireless communication from the first state to the second state.

16. The sensor system according to claim 11, wherein
the controller causes the sensor to detect the position of the wireless communication sensor at intervals of a first period,
the controller, when the status of wireless communication becomes the first state, causes the sensor to detect the wireless communication sensor after a lapse of a second time, and, when the position of the wireless communication sensor does not satisfy a first condition, starts control to cause the sensor to detect the position of the wireless communication sensor at intervals of the first period, and, when the position of the wireless communication sensor satisfies the first condition, starts control to cause the sensor to detect the position of the wireless communication sensor at intervals of the first period after a lapse of a third time, and
the controller stops control to cause the sensor to detect the position of the wireless communication sensor at intervals of the first period in response to a change of the status of wireless communication from the first state to the second state.

17. The sensor system according to claim 16, wherein
the controller detects the position of the wireless communication sensor in response to a change of the status of wireless communication to the first state and further detects the position of the wireless communication sensor after a lapse of the second time, and
the first condition includes a condition that there is no change in the position of the wireless communication sensor between before a beginning of the second time and after a lapse of the second time.

18. The sensor system according to claim 1, wherein
the wireless communication apparatus, when a second condition on at least one of data from at least one of the wireless communication sensors and the status of wireless communication with the wireless communication sensors is satisfied, sends instruction data to the at least one of the wireless communication sensors to detect the position of the wireless communication sensor.

19. The sensor system according to claim 18, wherein
the controller, when data detected by the sensor or another sensor of the wireless communication sensor satisfies a predetermined end condition, causes the wireless communication module to change the status of wireless communication from the second state to the first state,
the second condition includes a condition that the status of wireless communication of the wireless communication sensor of which the status of wireless communication is the second state is changed to the first state, and
the wireless communication apparatus sends the instruction data to another one of the wireless communication sensors, other than the wireless communication sensor of which the status of wireless communication is changed to the first state.

20. The sensor system according to claim 18, wherein
the controller causes the sensor to detect the position of the wireless communication sensor at intervals of a first period, and
a vibration state as the state of the base at intervals of a second period different from the first period,
the second condition includes a condition that data indicating a detection result of the state of the base from the wireless communication sensor of which the status of wireless communication is the second state satisfies a third condition.

21-23. (canceled)
